(19) United States
(12) Patent Application Publication
(10) Pub. No.: US 2009/0307052 A1
(43) Pub. Date: Dec. 10, 2009

(54) WORKFORCE PLANNING SYSTEM, METHOD AND TOOL

(75) Inventors: Amol Mankani, Mumbai (IN); Anant Bijoy Bhagwati, Mumbai (IN); Pratima Donde, New Bombay (IN); Ankur Vohra, New Delhi (IN)

Correspondence Address: ACCENTURE CHICAGO 28164;BRINKS HOFER GILSON & LIONE, P O BOX 10395, CHICAGO, IL, 60610, US

(73) Assignee: ACCENTURE GLOBAL SERVICES GMBH, Schaffhausen (CH)

(21) Appl. No.: 12/190,950

(22) Filed: Aug. 13, 2008

(30) Foreign Application Priority Data
Jun. 4, 2008 (IN) 1195/MUM/2008

(51) Int. Cl. G06F 17/30; G06F 17/50; G06Q 90/00

(52) U.S. Cl. 705/10; 705/7

(57) ABSTRACT

A method, system and tool are disclosed for planning workforce requirements for an organization, where the organization is organized into functional areas. An input is received of a workforce supply for the organization. An input is also received of a workforce demand. The workforce demand includes an organizational direction of the organization, including strategic planning and current performance of the organization, and includes productivity levers, which include productivity metrics for each of the functional areas of the organization. A workforce gap is forecasted by comparing the workforce demand to the workforce supply.

### CROSS-REFERENCE TO RELATED APPLICATIONS

This application claims the benefit under 35 U.S.C. 119(a) of Indian patent application no. 1195/MUM/2008 filed Jun. 4, 2008, which is incorporated by reference in its entirety herein.

### TECHNICAL FIELD

Generally a system, method and tool is described for planning for workforce needs of an organization, and more particularly for projecting anywhere from short to long term workforce needs, and taking corrective actions such as staffing increases or decreases, redeployment, and/or retraining.

### BACKGROUND

Management of a company's workforce has become increasingly important to business success. While many factors influence a company's ability to achieve high performance, none may be more important than the workforce. Technology, strategy, and innovative new products and services are important. However, the workforce may tie together the company, translating ideas and goals into results.

### BRIEF SUMMARY

A method, system and tool are disclosed for planning workforce requirements for an organization, where the organization is organized into functional areas. An input is received of a workforce supply for the organization. An input is also received of a workforce demand. The workforce demand includes an organizational direction of the organization, including strategic planning and current performance of the organization, and includes productivity levers, which include productivity metrics for each of the functional areas of the organization. A workforce gap is forecasted by comparing the workforce demand to the workforce supply.

Other systems, methods, tools, features and advantages will be, or will become, apparent to one with skill in the art upon examination of the following figures and detailed description. It is intended that all such additional systems, methods, features and advantages be included within this description, be within the scope of the invention, and be protected by the following claims.

### BRIEF DESCRIPTION OF THE DRAWINGS

FIG. 1 is a block diagram of a process framework of the workforce planning tool.

FIG. 2 is a block diagram of a workforce planning process flow.

FIG. 3 is a block diagram and a flow chart regarding an output of the workforce planning model.

FIG. 4 is a flow diagram of workforce supply estimation.

FIG. 5 is a block diagram of a gap analysis.

FIG. 6 is a flowchart of a gap fulfillment scenario.

FIG. 7 is a block diagram of a methodology to estimate the benefits of using the workforce planning tool.

FIG. 8 is a flowchart of a process of the workforce planning tool.

FIG. 9 is a screenshot of an organizational setup.

FIG. 10 is a screenshot of an exemplary data input sheet.

FIG. 11 is a screenshot of an exemplary function data input sheet.

FIG. 12 is a screenshot of a supply of personnel for the organization.

FIG. 13 is a screenshot of an estimate for workforce demand.

FIG. 14 is a screenshot that of estimates of workforce numbers and drivers.

FIG. 15 is a screenshot of a startup screen for viewing workforce demand trends.

FIG. 16 is a screenshot of demand trends which may be displayed when the view output button of FIG. 15 is clicked.

FIG. 17 is a screenshot of a startup screen for viewing estimates of workforce supply.

FIG. 18 is a screenshot of supplies for a determined sub-function.

FIG. 19 is a screenshot of a summary sheet of gap figures by job position, such as sales, and sub-function, at a particular level for determined years.

FIG. 20 is a screenshot of a workforce demand trends report.

FIG. 21 is a screenshot of a workforce gaps report.

FIG. 22 is a screenshot of add driver functionality, such as with regard to the set up new driver button of FIG. 14.

FIG. 23 is a flow diagram of a process of the workforce planning tool.

FIG. 24 is a block diagram of an exemplary productivity determination.

FIGS. 25A-K are screenshots of a first example of outputs using the workforce planning tool.

FIGS. 26A-J are screenshots of a second example of outputs using the workforce planning tool.

FIG. 27 is a screenshot of outputs of an exemplary benefit of using the tool, such as according to the methodology of FIG. 7.

FIG. 28 is a block diagram illustrating a general computer system of the tool.

### DETAILED DESCRIPTION

A system, computer implemented method and tool, hereinafter referred to generally as a tool, is disclosed that may be used to forecast a required size and makeup of an organization's workforce. The workforce demand for the organization may be determined by organization strategy, business plans and future direction of the organization/industry. For individual positions, the demand may be forecasted on the basis of productivity levers and productivity metrics. Current workforce numbers and trends/statistics on attrition, promotion, etc. may be used to quantitatively determine the projected work force supply. A workforce gap may be forecasted by comparing the workforce demand with the workforce supply.

To forecast the size and makeup, the tool may consider business strategies, organizational strategy and organization direction as inputs into the workforce planning tool. The workforce planning may be determined in accordance with scientific, quantitative analysis and industry benchmarks to assess personnel requirements. The personnel requirements may include a determined number of people for a particular function, e.g., position, for a given time, at present and/or in the future. The personnel requirements may be determined across the organization, such as across different geographic locations of the organization, and information collected and analyzed by the tool may be leveraged across industries. The tool may be customizable on a per organization basis.

With the tool, resources, such as personnel, may be optimized across business units of the organization. Costs due to over/under staffing and worked overtime may be reduced. Productivity may increase as appropriate personnel are staffed into positions proper for the personnel. Employee engagement may increase due to appropriate job alignment. Operationally, gaps in the workforce may be projected over the short, medium and long terms. The tool may be used to identify fulfillment scenarios for the identified gaps. A granularity of the workforce projection may increase as the time period decreases. For example, the tool may be used to identify that five field engineers are needed for an organization in India in April, but not May, and five field engineers are needed in the U.S. in May, but not April. Demand may be met by movement of the field engineers from India to the U.S. in May. In this way, and other ways, staffing demands may be met by people within the organization, such as through promotion. Demand may also be met in other ways. For example, the tool may trigger other internal fulfillment mechanisms, e.g., transfers, job rotations, and training. The tool may also trigger external fulfillment, such as through workforce recruiting.

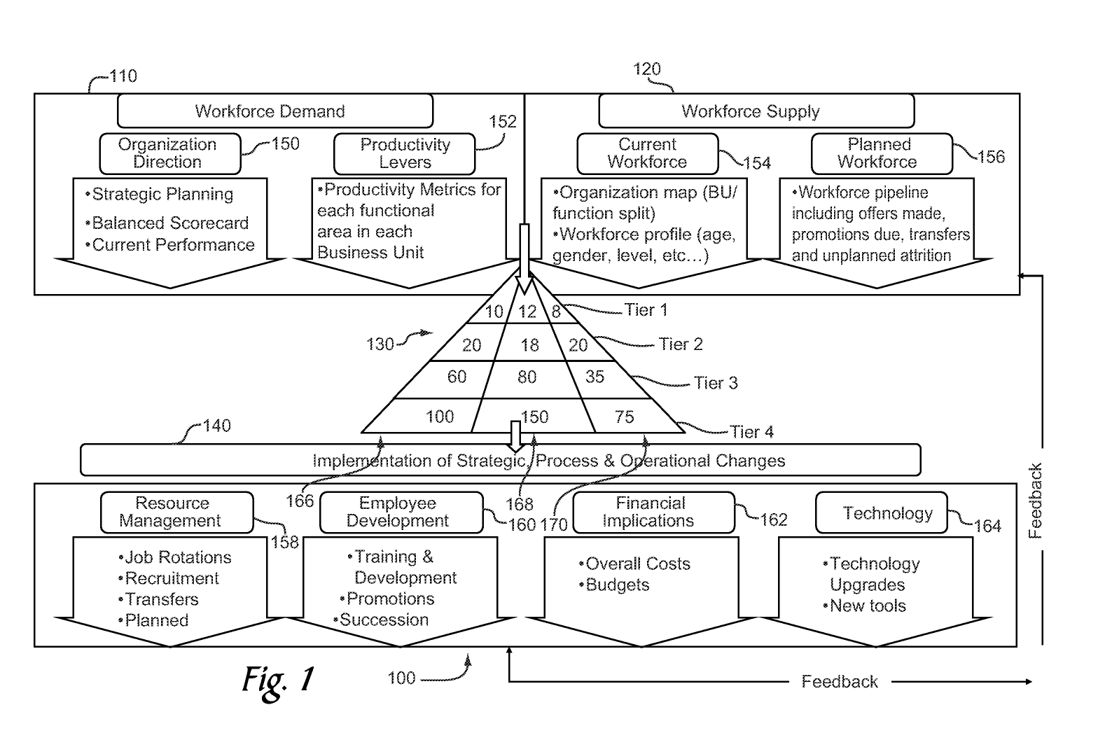

FIG. 1 is a block diagram of a workforce planning process framework of the tool 100. The tool 100 may be implemented on a local computer of the user, such as using EXCEL, may be a client/server run application, and/or may be a web based application. Workforce planning may include mapping current personnel needs and predicting future needs. The needs may vary depending on the type of organization, such as whether the organization is a private company or governmental agency. The workforce planning may aid an organization in achieving better business performance and meeting business goals. The framework of the workforce planning process includes: workforce demand 110, workforce supply 120, a workforce pyramid 130 (gap analysis), and an implementation block 140 of strategic, process and operational changes. The workforce pyramid 130 may represent gaps in the workforce for an organization. With the framework, the tool 100 may project an organization's workforce needs, such as in accordance with business plans, growth forecasts and people drivers. The tool 100 may be used to project the ability of the organization to fulfill those requirements with current and planned resources. The tool 100 may estimate the gap in required workforce and aid the organization in taking corrective actions to set in motion activities to address the business needs.

Workforce demand 110 relates to workforce requirements, such as in terms of personnel, staff, employees, etc., of the organization. The workforce demand 110 is for a determined time period, e.g., over the next several years. The personnel requirements may be based on the organization's strategic objectives and growth targets. The workforce demand 110 may include organizational direction 150 for the organization. The organization direction may be documented or captured in strategic planning documents, or in the form of a balanced scorecard for the organization and its various functions. The balanced scorecard may translate a company's strategy into a set of determined and measurable performance parameters. The measures are typically set along the quadrants of the balanced scorecard, including: FINANCIAL METRICS, OPERATIONAL METRICS, CUSTOMER METRICS, LEARNING & GROWTH METRICS. The balanced scorecard is a widely used strategic management tool for measuring performance.

The workforce demand 110 may also include productivity levers 152, such as people lever, and productivity metrics. People levers are used in workforce size determinants. For e.g. target revenue may be a people lever as an organization may require fewer/greater full time employees if its revenue targets change. Other people levers may be number of customers, production volumes, number of accounts managed, etc. Productivity levers/productivity metrics apply to a unique job and provide the scientific basis for determining the work force demand. For example, an organization focused on maximizing revenue, might look at revenue per full time employee as a suitable productivity metric. In another example, a production based organization may use volumes produced per full time employee as a suitable productivity metric and use it to determine work force numbers. The productivity metrics may be for each functional area, business unit, etc. of the organization.

Workforce supply 120 may relate to current and planned availability of an organization's workforce. Workforce supply includes current workforce 154, e.g., the number of personnel, also referred to as people, staff, employees, etc., within the organization, including organization map per business unit and/or functional split, and a workforce profile, such as by age, gender, and level of experience. The workforce supply analysis may be tabulated on the basis of the organization structure. The organization may be structured on the basis of functions (Sales, Marketing, Finance, IT, HR) or Geographically (India operations, EMEA), etc. The tool 100 may be customized to fit the relevant organization structure to tabulate the workforce supply figures. Workforce supply may also include planned workforce 156, including a workforce pipeline of offers made, promotions due, and transfers, less unplanned attrition.

Using the workforce demand 110 and workforce supply 120, a gap analysis may be performed to determine a gap between a required and existing workforce, if any. The gap may be the workforce demand 110 minus the workforce supply 120. A negative value for the results means that there is more supply than demand. Information from the workforce demand 110 may be fed into the workforce pyramid 130, and information from the workforce pyramid 130 may be fed into the implementation block 140, and information from the implementation block 140 may be fed to workforce supply 120, such that appropriate mechanisms may be triggered to reduce the mismatch between workforce demand and workforce supply. For example, a gap in the workforce may be filled by obtaining help from within and/or from outside of the organization. Also attrition or other ways may be used to trim supply if the supply is greater than the demand.

The workforce pyramid 130 for the organization may be divided into multiple tiers, where the tiers may mirror levels of the organization being analyzed, such as from top to bottom. For example, tier 1 may represent an executive, tier 2 may represent engineers, etc., through tier 4 that may represent field workers. The tiers may represent other and/or different types of positions or organization levels, such as analyst, consultant, team manager, etc. The tiers may be divided, such as into areas 166, 168 and 170, to represent different functions, e.g., operational groups and/or teams of a business, within the organization. The number within the tier 1-4 for the area 166, 168 and 170 may represent the gap number of personnel needed for the position with the group. More or less than four tiers and more or less than three areas may be used depending upon an implementation, such as a setup of the organization. The number of tiers and areas to be used may be determined by the organization structure.

The implementation block 140 may include resource management 158, employee development 160, financial implications 162 and technology 164. Resource management may take into consideration job rotations, recruitment, transfers and planned attrition to meet a level of required personnel. Employee development 160 may consider training and development, promotions and succession planning. Financial implications 162 may include overall costs, such as outsourcing manpower versus in-house personnel, and budgets. From the implementation 140, the workforce supply 120 may increase. For example, if the organization has one sales engineer and two sales managers, and decides to promote the sales engineer to a sales manager, then the gap for sales engineers may increase by one and the gap for sales manager decrease by one. The feedback may work for one cycle per determined time period, such as for a particular year. Other time periods may be used, such every six months, quarterly or monthly, etc. The new workforce supply 120 and workforce demand 110 can be compared to the needs identified in the workforce pyramid 130, and a new gap analysis may be performed to provide for a deficit or account for a surplus of personnel.

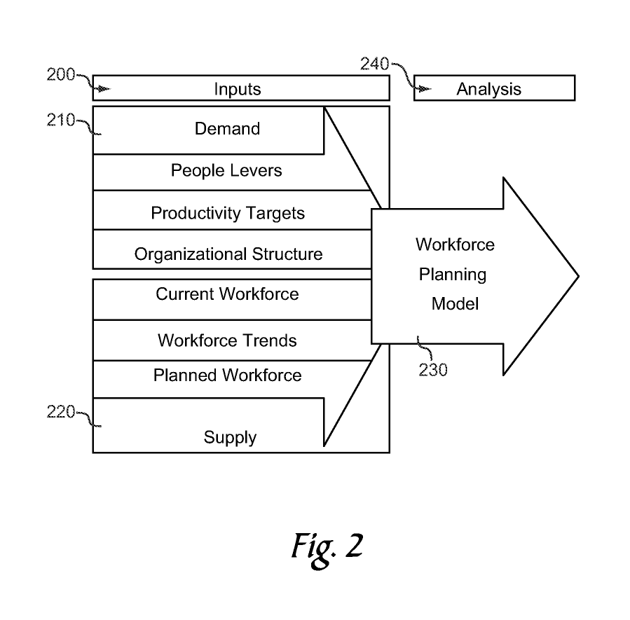

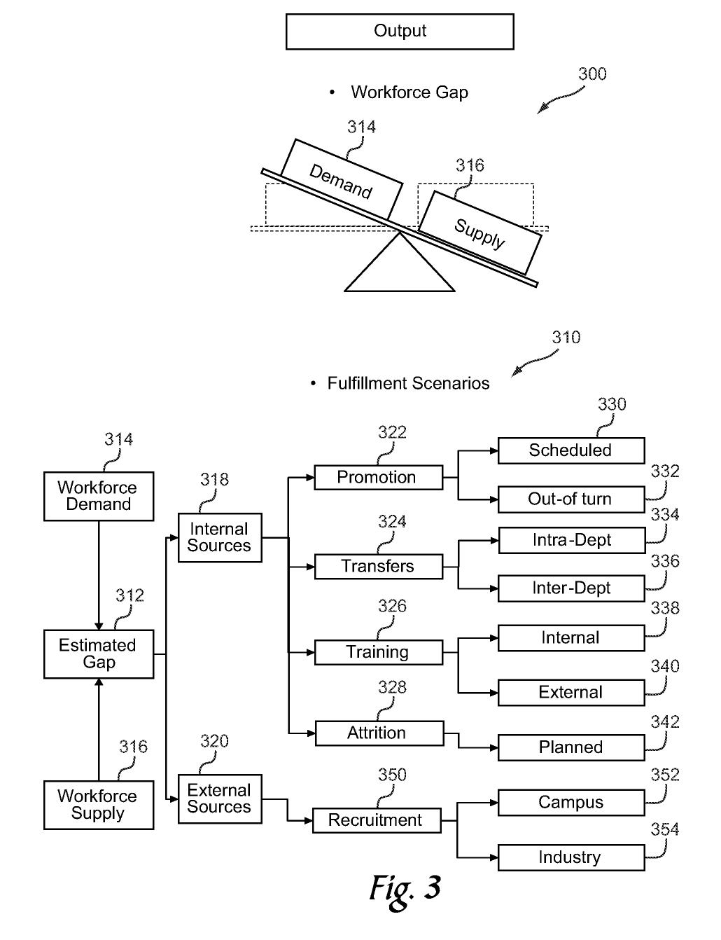

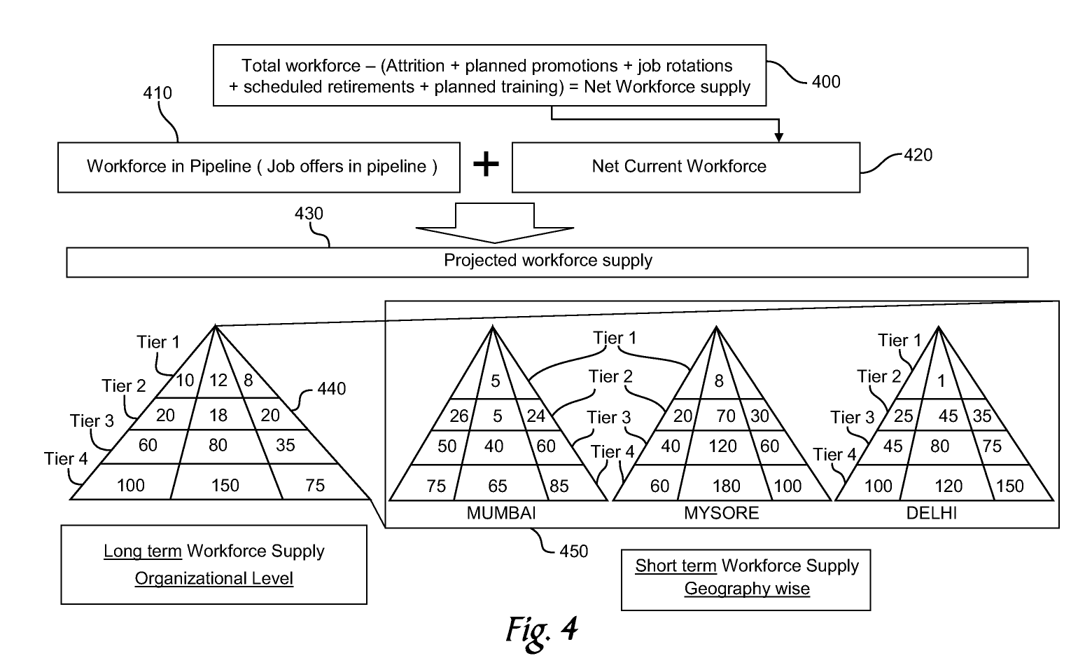

FIGS. 2 and 3 are block diagrams of a workforce planning process flow. In FIG. 2, workforce demand 210 and workforce supply 220 may be inputted to a workforce planning model 230 to be analyzed 240. The demand 210 may include people levers, productivity targets, and organizational structure needs. The supply 220 may need to be increased to meet the demand 210, such as to fill an organization need. Supply 220 includes current workforce, workforce trends, and planned workforce additions. The workforce planning model 230 computes the actual workforce based on demand 210 and supply 220.

FIG. 3 is a block diagram and a flow chart of an output of the workforce planning model 230. The output may include a workforce gap analysis 300 of current workforce demand versus supply. The output may also include fulfillment scenarios 310. For the fulfillment scenarios 310, the estimated gap 312 may be determined from the workforce demand 314 and the workforce supply 316. The tool may provide recommendations about filling the estimated gap 312 by internal sources 318 or external sources 320, or a combination thereof. Internal sources 318 for attending to the estimated gap 312 include promotion 322, transfers 314, training 326 and attrition 328, e.g. if the workforce supply 316 exceeds the workforce demand 314. Promotions 322 may be scheduled 330 or out of turn 332, or both. Supported by output from the tool 100, transfers 324 may be intra-department 334 or inter-department 336, or both. Training 326 may include internal 338 or external 340 training, or both. Attrition 328 may be planned 342. External sources 320 for filling an estimated gap 312 include recruitment 350 of personnel. The recruitment 350 may be campus 352 recruiting, or other types of recruiting such as industry 354 recruiting.

FIG. 4 is a flow diagram of workforce supply forecasting. An organization includes a current workforce 400, and also workforce in the pipeline 410, such as based on attrition trends, planned promotions, scheduled retirement and planned training, e.g., for another position within the organization. Data for the pipeline may be based on industry benchmarks for the organization, similar types of organizations or internal benchmarks. A net current workforce 420 or remaining workforce may be the current workforce taking into consideration the workforce in the pipeline. In accordance with industry benchmarks and/or input from separate business unit (SBU) heads, human resources (HR), and recruitment a projected workforce supply 430 may be determined. The benchmarks may be based upon trends across industries. The projected workforce supply may be displayed in supply pyramid 440. The supply pyramid 440 may be for a determined time frame and entity, such as long term workforce supply at an organizational level. Other supply pyramids 450 may be used to display other time frames and entities, such as a short term workforce supply by geographic location of entities within the organization. Short term may be one to four years, and long term for a period greater than four years. The numbers in the pyramids 440, 450 may represent personnel needed at each tier. The numbers for the short term workforce supply for all the geographical entities may add up to the short term workforce supply for the whole organization.

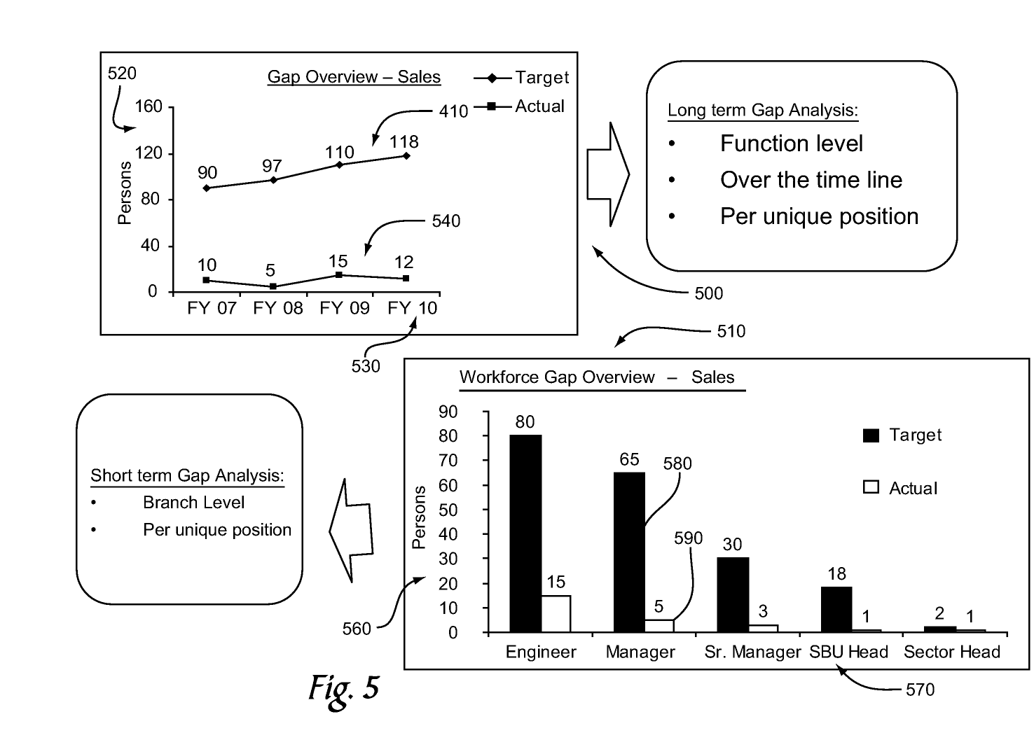

FIG. 5 is a block diagram of an exemplary gap analysis. Gap analysis may be accomplished for workforce planning at a functional level 500, a branch level 510, such as by a geographic location, or both. At the functional level 500, the gap may be tracked by personnel 520 over time 530. Actual 540 and target 550 personnel may be displayed. There may be a separate chart for each function, such as sales (shown), production, manufacturing, etc. At the branch level 510, the gap may be shown for personnel 560 over unique positions, such as engineer, manager, senior manager, SBU head, sector head, etc. A branch level 510 may be a branch office of an organization, such as a Chicago office of a Swiss corporation. The branch target 580 and branch actual 590 personnel may be displayed. Again, there may be a separate chart for sales, manufacturing, and production, and any other functions of the organization.

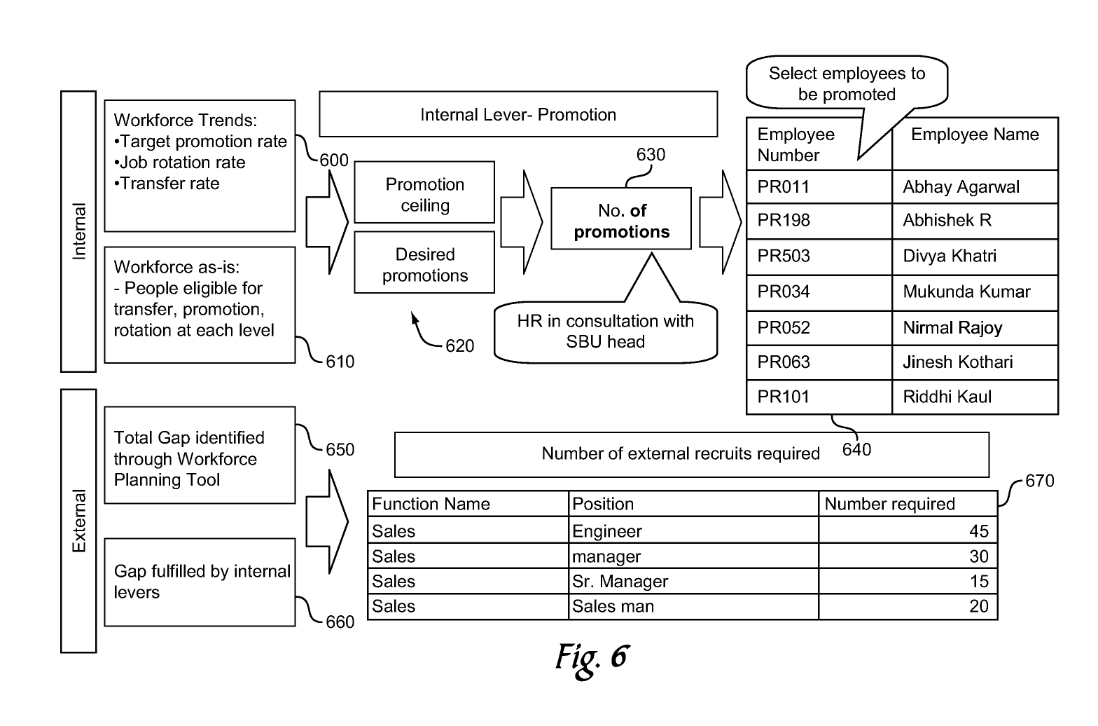

FIG. 6 is a flowchart of a gap fulfillment scenario. Gaps in personnel may be filled internally, by leveraging personnel within the organization, or externally, such as through recruiting. At block 600, the tool 100 helps a user consider workforce trends, such as target promotion rate, job rotation rates and transfer rates. At block 610, the tool 100 may also be used consider the actual current workforce of the organization, including people eligible for transfer, promotion, and rotation, for each level. From the trends and actual workforce, at blocks 620 the tool 100 may determine whether there is a promotion ceiling due to a surplus of personnel, or whether promotion is desired due to a deficit of personnel, for the particular position such as sales managers. At block 630, the tool 100 makes a recommendation regarding a number of promotions, from zero on up. The tool 100 may also make a recommendation for a preferred amount of demotions, depending on the workforce gap analysis. The organization, such as HR and/or an SBU head may review the recommendation of the tool 100 to determine an amount of personnel to promote. At block 640, employees eligible for promotion may be displayed, such as in a list. The tool 100 allows the user to select an employee to be promoted from the list.

At block 650, the tool 100 may also identify a gap in personnel that cannot be filled from within the organization. At block 660, the tool 100 may identify a gap that can be filled by internal levers. From the identified gap and internal levers, at block 670 the tool 100 can determine an amount of external recruits required to fill the gaps. The tool 100 may display the department or function name, the position, and the number of personnel required to fill the gaps. As such, for each position a number of personnel needed may be listed.

In such a way, the tool 100 may provide visibility of positions in which there is excess manpower or deficit, such that the personnel in the organization may be right-sized. The tool 100 may bring a structured approach to project workforce requirements. The tool 100 may provide for clarity of drivers of personnel throughout the organization, instead of only a position by position basis. Organization structure may evolve and new jobs created based on the information provided by outputs from the tool 100. Organizations may factor in other aspects of capacity utilization across various functions within the organization. The tool 100 provides for the articulation and factoring of productivity improvements at various functions. The tool 100 may also enable the functional head of a group within the organization to review and track the productivity levels in the past, present and for the future.

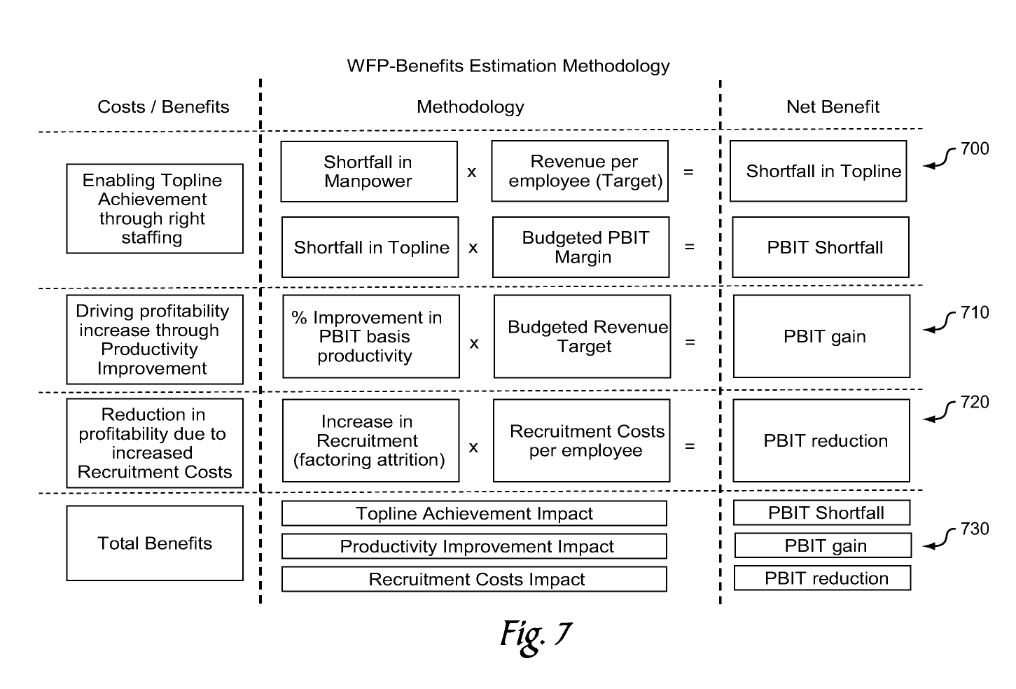

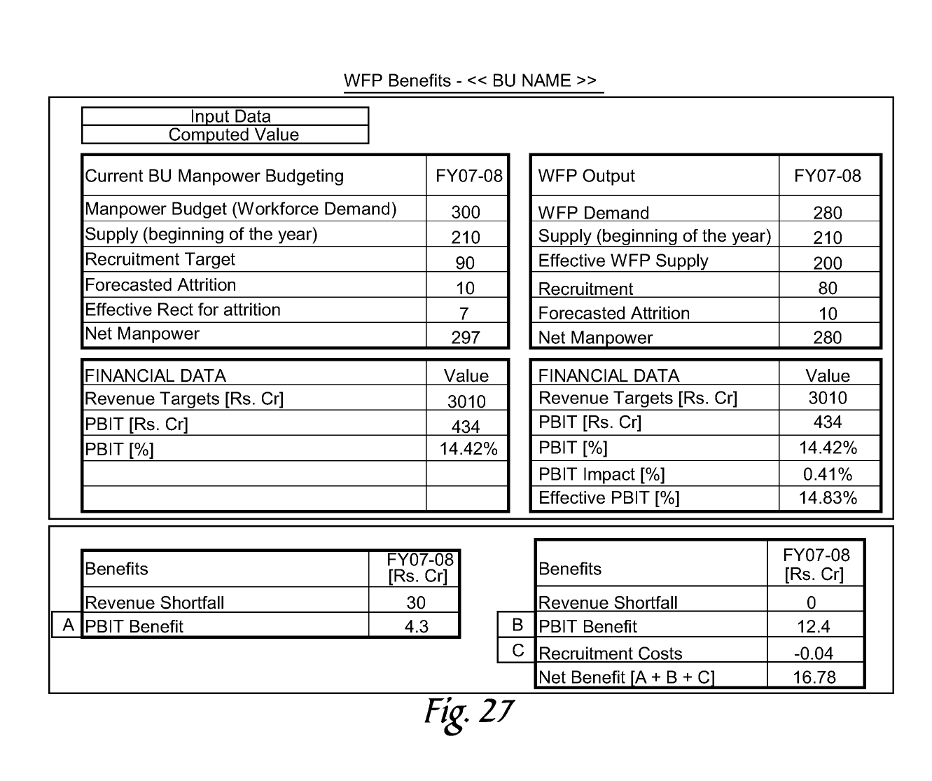

FIG. 7 is block diagram displaying estimated benefits of using the workforce planning tool 100. An algorithm of the tool 100 may perform estimates to help an organization meet top-line performance targets, such as through optimizing personnel use throughout the organization. In row 700, a benefit of enabling top-line achievement through right-staffing may be determined. A shortfall in manpower times a revenue per employee equals a shortfall in top-line. The shortfall in personnel or manpower may be forecasted by the tool 100. The shortfall in top-line times a budgeted profit before interest and taxes (PBIT) margin gives a PBIT shortfall. In row 710, driving profitability increase through productivity improvement may be determined. A percentage of improvement in PBIT basis productivity times a budgeted revenue target equals PBIT gain. In row 720, a reduction in profitability due to increased recruitment costs may be determined. An increase in recruitment, which may factor attrition, times recruitment costs per employee equals a PBIT reduction. Total benefits for a sum of top-line achievement impact, productivity improvement impact and recruitment costs impact may provide a net benefit in terms of PBIT shortfall, PBIT gain and PBIT reduction. In FIG. 27, and exemplary calculation of estimated benefits of using the tool 100 is set forth.

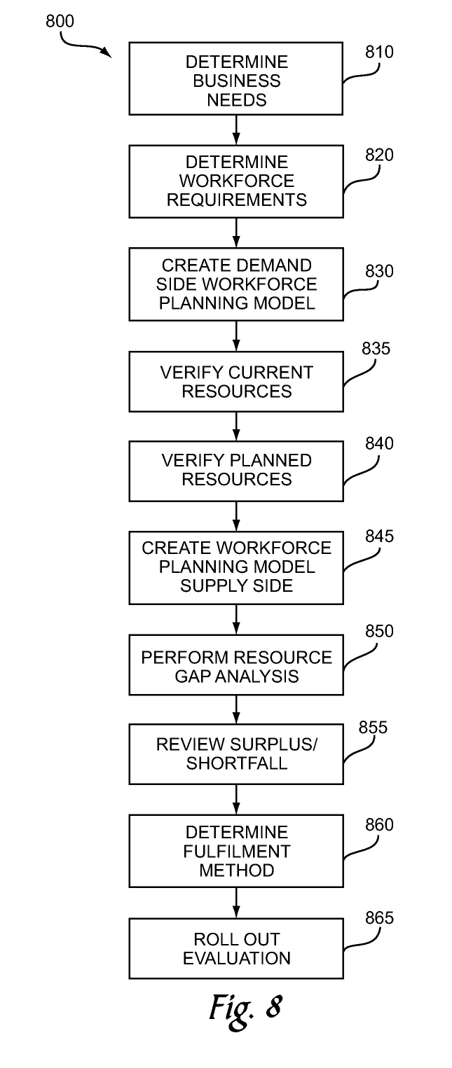

FIG. 8 is a flowchart of a process 800 of the workforce planning tool 100. At block 810, business needs and/or intent of the organization may be determined and factored by the tool 100. The tool 100 may take into consideration strategic plans and business priorities. For example, the organization may wish to raise revenue by a determined percentage over the next year. Other factors may include current business requirements, future business plan, strategic intent, and productivity metrics by position, some or all of which may be used by the tool 100 to identify required personnel. Current and target revenues are captured. In such ways, the tool 100 may be customizable across various organizations and over multiple industries, depending on how the organization is structured and functions. Benchmarks may be considered by the tool 100 on an organization to organization basis. In terms of demand estimation, different factors at different points in time for different organizations may be used by the tool 100. In terms of productivity metrics, to factor in business plans, the tool 100 is adaptable to accommodate different elements/factors applied across different organization and/or offices within an organization.

The demand side details may be SBU, product and/or line of business specific. For example, a particular group of an organization may include analysts, consultants, senior managers and senior executive positions. The business intent for the group may be one billion in revenues. Productivity requirements may be determined for each position. For example, the analyst may be chargeable at 80%, consultants at 60%, senior managers at 40% and senior executives at 20%. In accordance with a workload at each position and the determined productivities, the tool 100 may determine an amount of personnel to staff at each position to meet the target business intent. If no productivity level is available for a particular position, the tool 100 may use a span of control figure. The span of control may be determined as the number of direct/indirect reports that a particular supervisor is able to manage on a day to day operational basis.

To ensure consistent outputs, financial forecasts may be confirmed and frozen during the determination process. From the gathered information, value scorecards may be determined for various functions of the organization. The scorecards may include a perspective of what function is about, and key deliverables for function. In accordance with performance indicators on which the functions were measured, needs that drive the business may be better understood. The business needs may relate to demand workforce drivers which may be apply/quantify workforce requirements based on those needs.

At block 820, workforce requirements may be determined. Productivity metrics and target levels may be finalized for each function based on industry benchmarks and existing functional scorecards. Current productivity levels may also be determined. Role details may be collated from groups within the organization, such as HR, or from without, such as by consultants, for each function and level, such as consultants, managers. At block 830, a demand side workforce planning model may be created. The planning model may forecast workforce demand incorporating financial and productivity forecasts, such as by SBU, function, level and geographic location.

At block 840, current resources, such as in terms of personnel, may be verified for the organization. Current workforce levels and roles may be captured by SBUs, functions, levels and positions. Employee profiles may be collated, such as for age, gender, grade, pay and service tenure. Current statistics and/or trends in promotions, demotions and attrition may be gathered. In accordance with the statistics, at block 845, a workforce planning model for the supply side may be created to access current and planned workforce, such as by SBU, function, level and geography. For example, for a particular year, there may be twenty-five analysts, and a determined attrition rate of twenty percent. The attrition rate may be determined by reviewing past attrition trends, or in other way, such as by viewing industry benchmarks. If two analysts have left their position the actual number of analysts is twenty-three, and factoring in attrition, the actual supply is twenty. Analysts in the pipeline may also be considered. If three analysts have been offered positions, and they accepted the actual number of analysts is twenty six. The tool 100 may also take into consideration known transfers and promotions of current personnel. If on average twenty percent of analysts are promoted every year, and there are many high level analysts at the time the tool 100 is used, the actual expected supply of analysts may be determined accordingly.

At block 850, gap analysis may be performed, to determine if expected supply meets demand, such as by position and function. The gap analysis may provide a number of resources required to meet demand, across SBUs, positions, functions and lines of business. Demand and supply determinations may be validated by the organization, such as with input from management and function heads. The tool 100 may use the determinations to build workforce scenarios. At block 855, personnel surpluses and shortfalls may be reviewed. Any gaps identified by the tool 100 may be validated by the organization, such as by management. As such, estimates for attrition, promotion, etc. and other factors may be updated periodically or each time the tool 100 is used.

At block 860, personnel fulfillment processes may be determined. Fulfillment includes identifying and finalizing alternatives to meet the gap in workforce requirements. Guidelines to select the fulfillment process may be defined. For example, personnel may be recruited to fill the gap, and/or a surplus of analysts from one group in an organization may be used to fill a gap in another group. A handover process, such as for promotions, to the respective team may be designed.

At block 865, fulfillment may be rolled out and evaluated. In such ways, the tool 100 may be used to aid the organization in handling workforce gaps. The workforce planning process, such as function-wise in each SBU, may be implemented. A revised workforce gap analysis pyramid may be estimated based on actions initiated. An evaluation process and frequency of review of the workforce planning, including financial targets and productivity metrics, may be determined. In such ways, the tool 100 may be used to aid an organization with internal restructuring of operations, change in organization strategy, accelerated growth, productivity review, and/or enhancement of the workforce, etc. A designed and executed workforce planning process may contribute to the organizations' ability to respond appropriately to internal and external business drivers. The tool 100 may be used to reduce implementation time, lower a risk of strategy deployment, lower a cost of implementation and enhance know how and consistency.

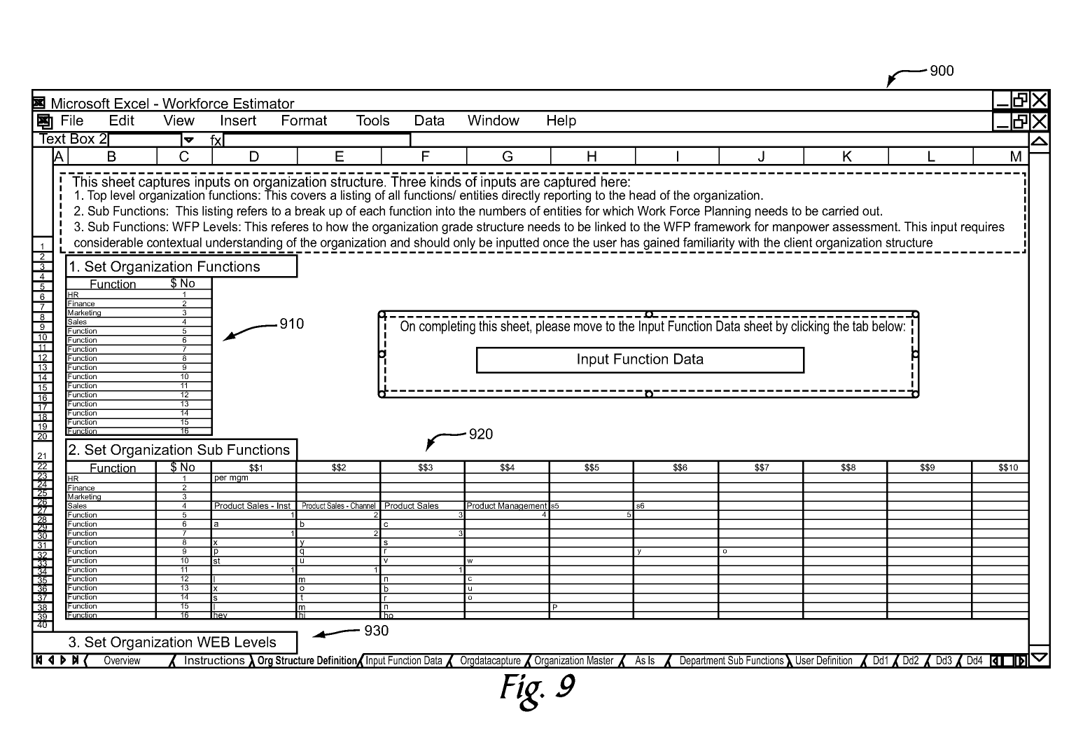

FIG. 9 is a screenshot 900 for an exemplary organization setup. Organizational functions/departments 910 are established, such as HR, finance, research and development, customer service, marketing, sales, manufacturing, etc. The tool 100 may be customized to allow different organization structures across industries and geographies. The listing of functions may cover each function/entity that reports directly reports to the head of the organization. Sub-functions 920 related to the functions may be entered and displayed. The sub-functions may be the entities for which workforce planning is carried out. For example, sales may include product sales by channel, project sales, and project management. A grade/career level structure 930 may be determined for each department and/or function. This may refer to how the organization grade structure is linked to the workforce planning framework for manpower assessment. A familiarity with the organizational structure may be used to determine the proper inputs.

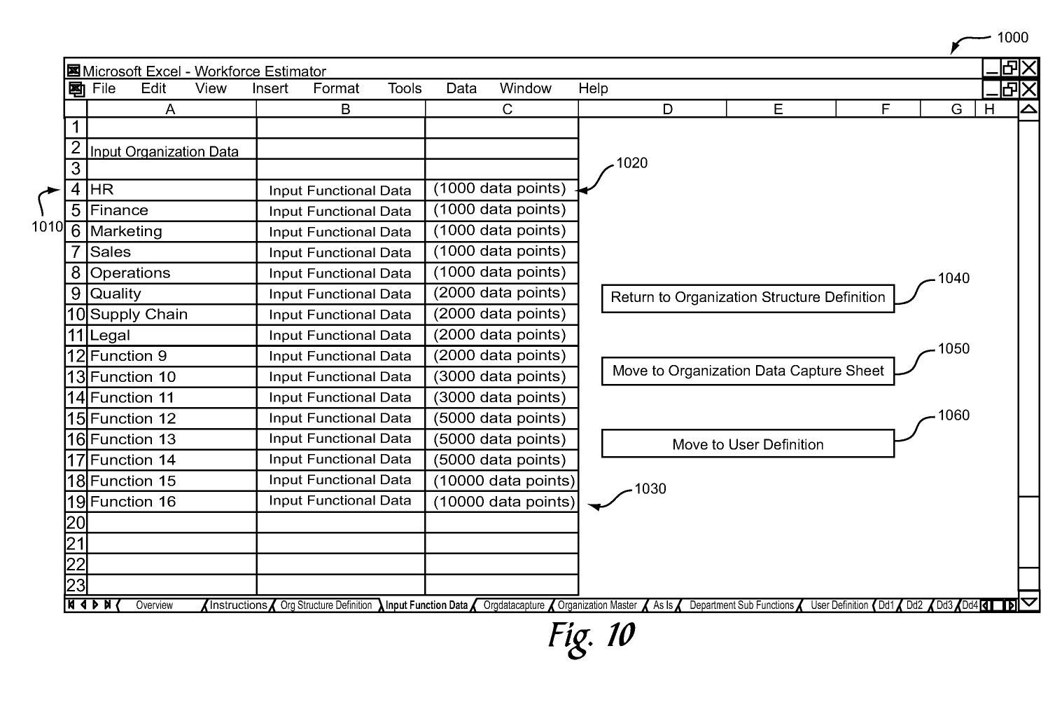

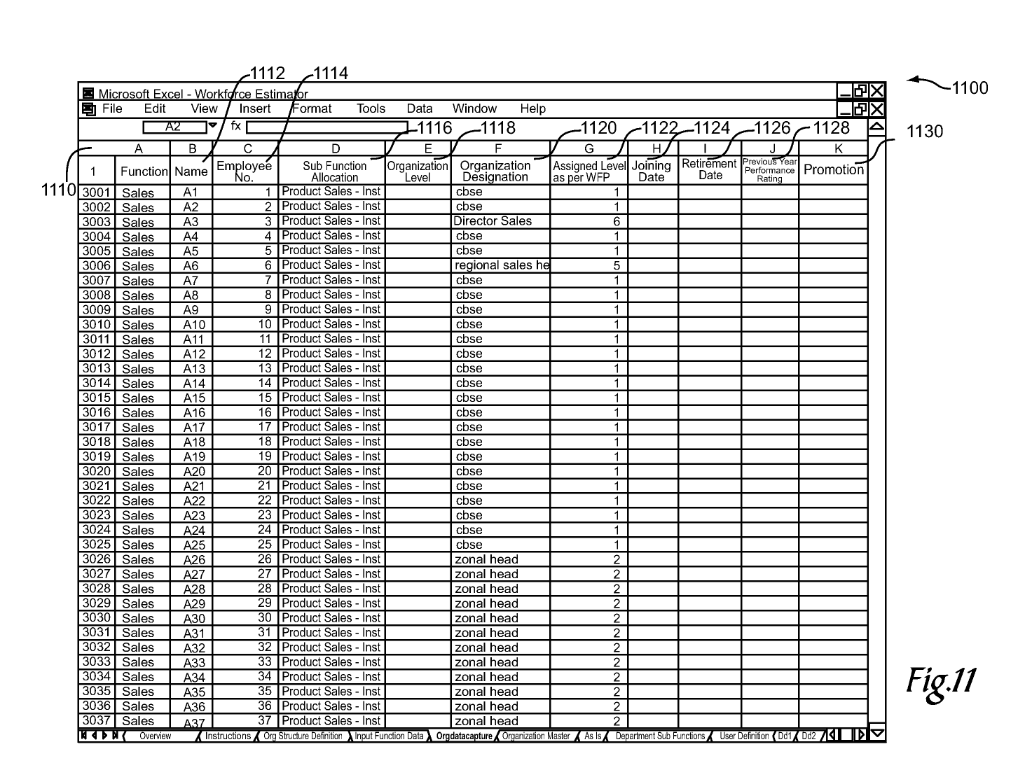

FIG. 10 is a screenshot of an exemplary data input sheet 1000 template. The data input sheet 100 may operate with an application such as EXCEL by MICROSOFT, or other application. The data input sheet may contain a list of functions 1010 of the organization, such as HR, finance, marketing and sales, and/or other functions such as operations, quality, supply chain and legal. The data input sheet 1000 may include fields 1020 that correspond to each function 1010 to allow a user to input functional data for each function. A number of data points 1030 may also be listed by each function 1010. The data input sheet 1000 may also include icons for one click movement to other sheets, such as an organization structure definition button 1040, an organization data capture sheet button 1050 and a user definition button 1060.

FIG. 11 is a screenshot of an exemplary function data input sheet 1100. The function data input sheet 1100 may capture employee demographic data by function 1110, such as sales, for the organization. The stored demographic data may include information such as employee name 1112, employee identification number 1114, a sub-function allocation 1116, such as product sales, organizational level 1118, organization designation 1120, an assigned level 1122, a date joined 1124 the organization, a date recruited 1126, previous year performance rating 1128, performance data 1130, promotion history and job rotation history, and or other data such as career level and grade. The fields of the data input sheet 1100 may change depending on an implementation. The entered data may provide for a good overview of the structure of the organization, and the supply of personnel.

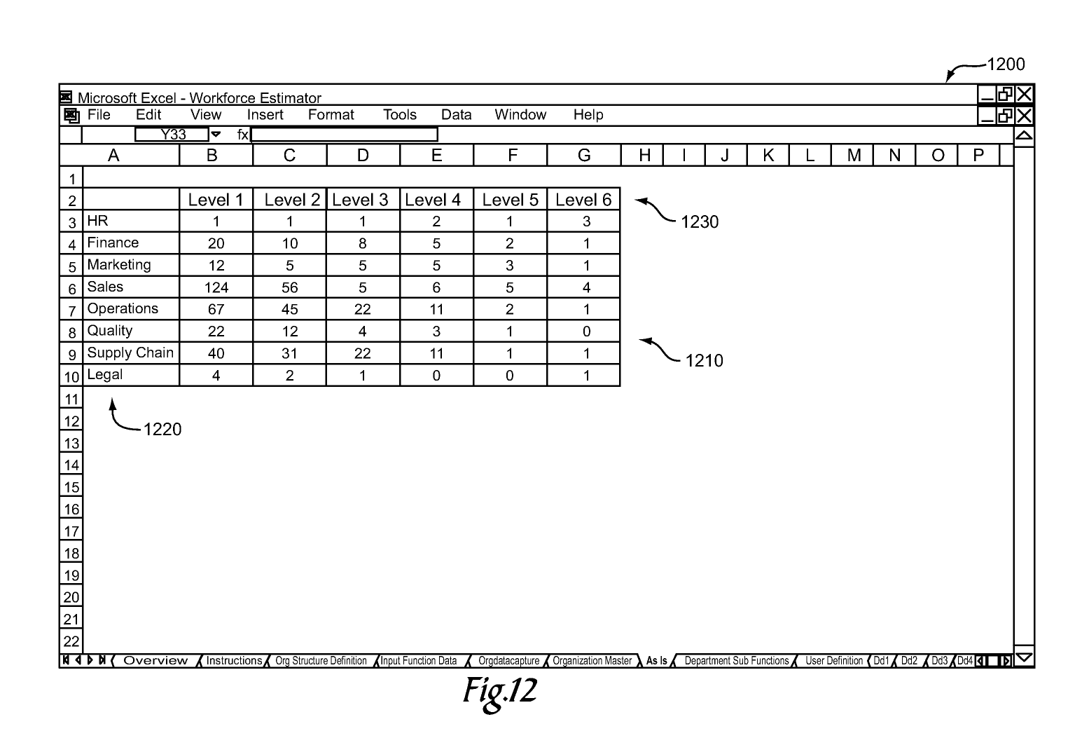

FIG. 12 is a screenshot 1200 for inputting a supply of personnel, such as workforce supply, for the organization. The screenshot 1200 may include a summary of the workforce supply 1210, e.g., the current number of personnel, by function 1220 for different levels 1230 of the organization. For example, for the sales function, level 1 employees, there are currently 124 personnel at the organization. The tool 100 may compute this amount on a query command.

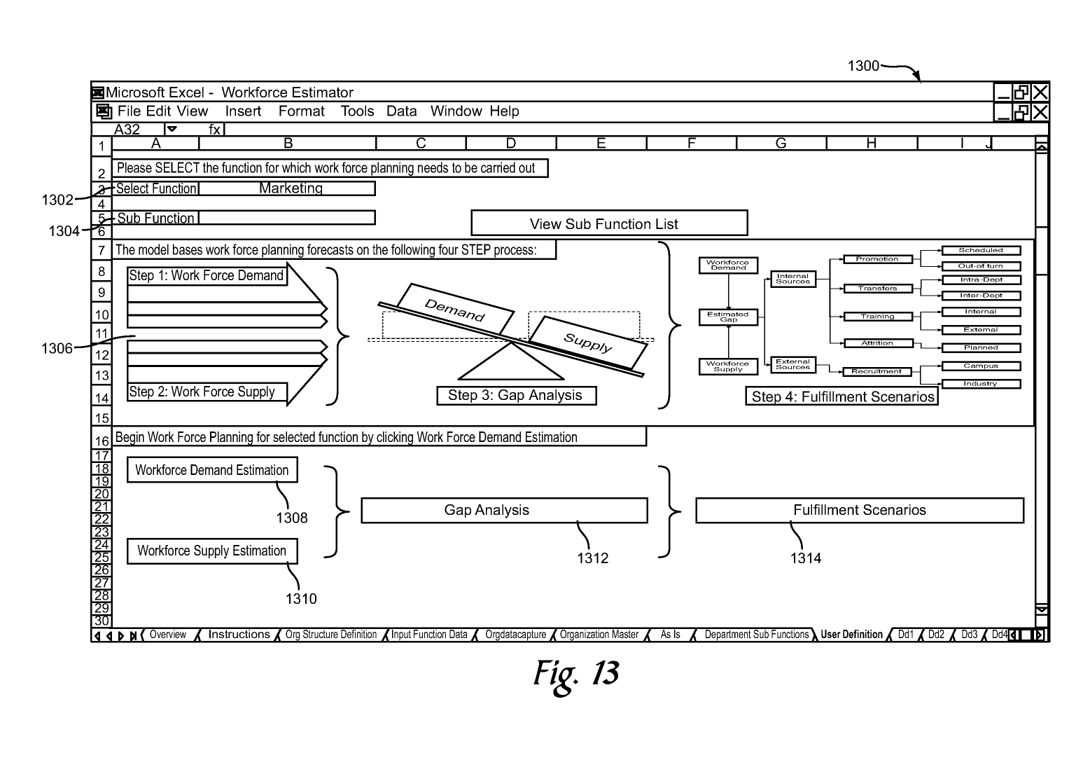

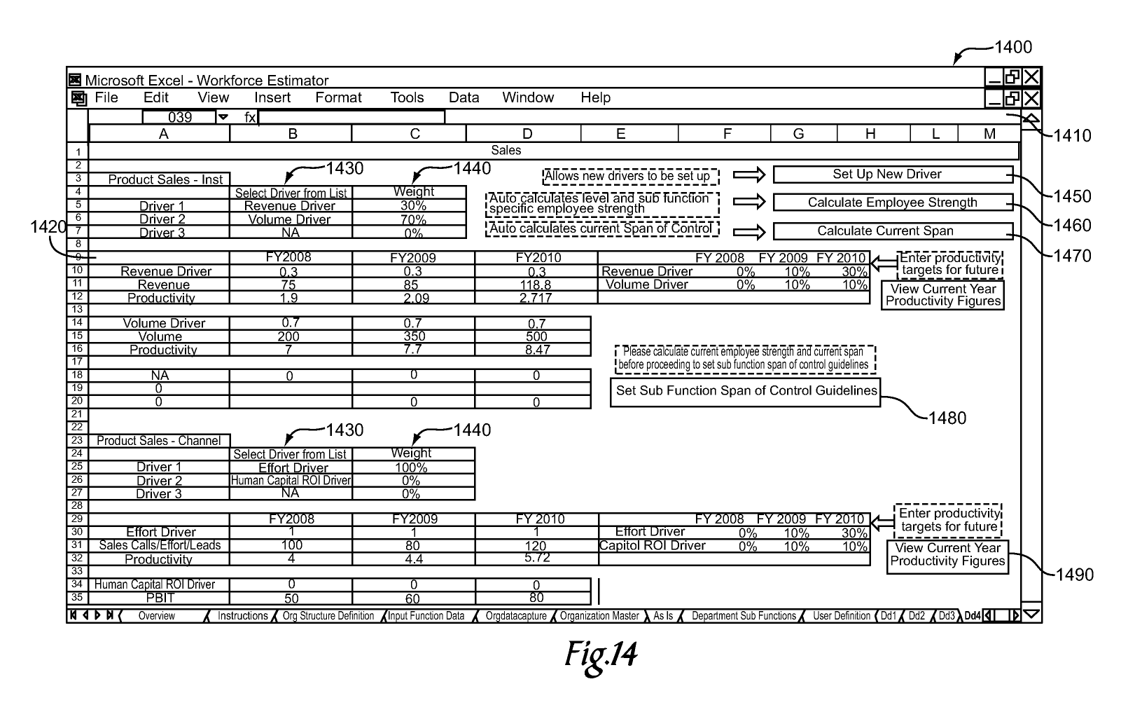

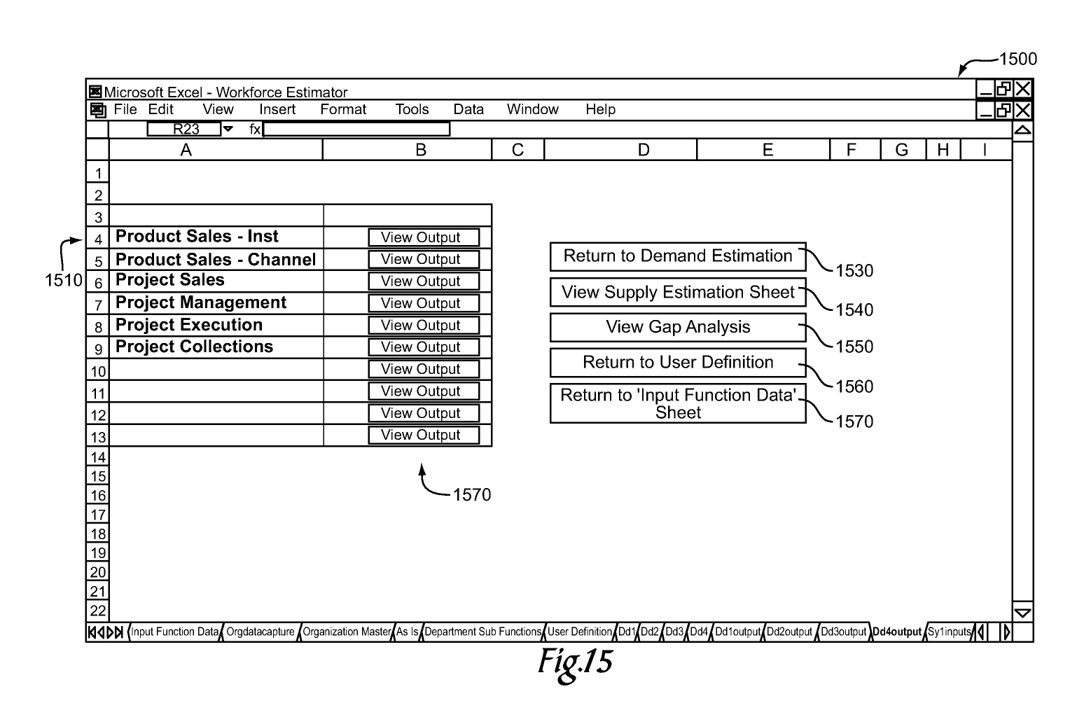

FIG. 13 is a screenshot of a workforce demand estimation control sheet 1300 to estimate workforce demand. At field 1302, a function to be analyzed may be selected. A sub-function to be analyzed may be selected at field 1304. Since the user definition sheet 1300 allows movement between functions or the organization structure, the user may toggle and navigate between the different functions and different stages of the workforce planning exercise using the user definition sheet 1300. A model basis 1306, such as described earlier in FIGS. 2 and 3, may be displayed in the screenshot 1300. As such, workforce planning may be carried out at a function, and sub-function, level. The user definition sheet 1300 may act as a control sheet during the workforce planning process. The sheet 1300 may include a workforce demand estimation button 1308, a workforce supply estimation button 1310, a gap analysis button 1312 and a fulfillment scenarios button 1314 to allow quick access to different parts of the tool 100.

To run workforce planning for marketing, for example, the user may select the marketing function 1302 and then click the workforce demand estimation button 1308. Once functions have been determined in the organization structure definition, the user definition sheet 1300 may automatically update. The workforce planning analysis may be carried out as per the current organization structure of the concerned organization. The structure inputs once captured in the tool 100 may be stored in the database, and all work force planning fields related to the structure may be automatically updated using relational database management systems.

FIG. 14 is a screenshot 1400 that displays estimates of workforce numbers and drivers. The screenshot displays workforce demand estimates per function 1410, such as sales. The estimates may be calculated over a number of years, 1420, such as three years. The estimates may be in accordance with personnel levers and productivity metrics, productivity metric enhancement targets, desired span of control, and current workforce trends and span of control. The desired span of control may be in accordance with industry benchmarks. The people levers and productivity metrics may be established by the user. For example, for a consultant, chargeability metric may be established, or for sales, a number of units sold per month or other time period. The users may add their own productivity metrics in accordance with industry/organization context by changing the driver fields 1430. As the tool 100 is used in different industries, more and more drivers may be added. Drivers may include revenue drivers, volume drivers, effort drivers, and human capital return on investment (ROI) drivers. At weight fields 1440, the user may also weight the various drivers, such as by designating a percentage. As such, the tool 100 takes into consideration productivity metrics when estimating workforce.

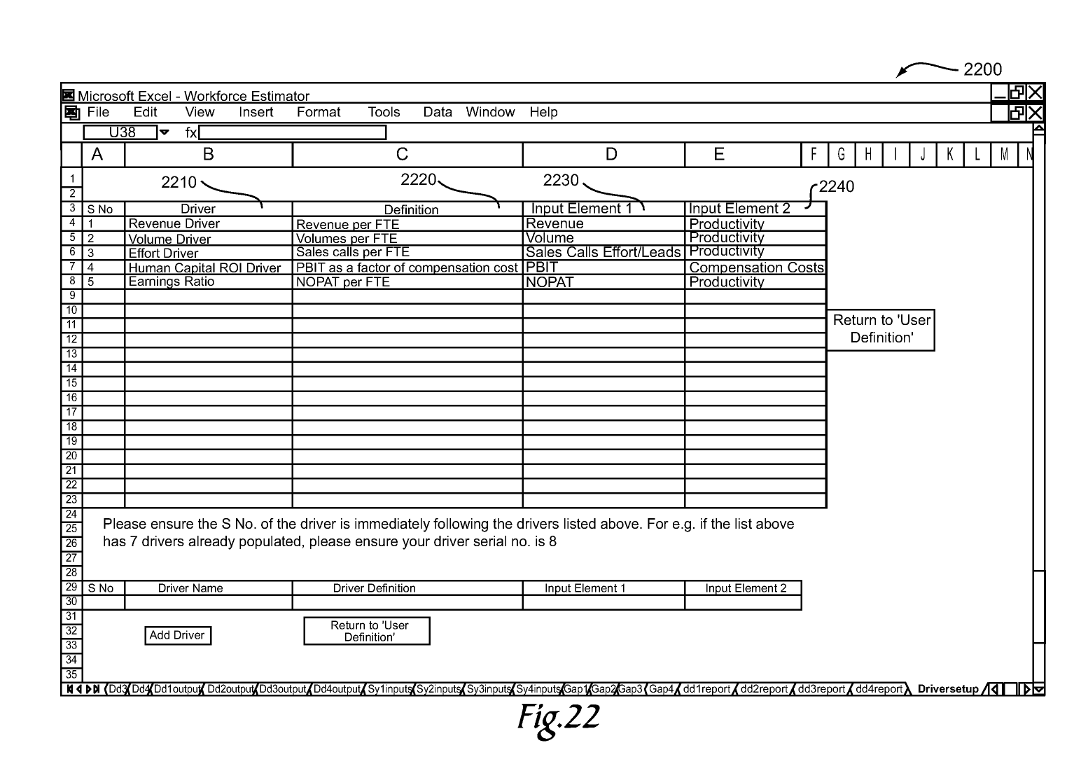

The screenshot 1400 may also include a setup new driver button 1450, calculate employee strength button 1460, a calculate current span button 1470, a setup span of control guidelines button 1480 and a view contact year productivity figures button 1490. The setup new driver button 1450 allows the user to establish new drivers, such that metrics may be determined as a value for a particular function for a particular job position. An exemplary screen for adding drivers is in FIG. 22. The calculate employee strength button 1460 automatically calculates level and sub-function specific employee strength for the user. Since an amount of employee personnel is known from the tool 100, employee strength may be determined, such as on the basis of data uploaded. The calculate current span button 1470 may initiate calculation of current span of control, such as by determining how many analysts report to a consultant. For example, for an organization, using the information entered into the tool 100, when the calculate current span button is clicked, the tool 100 may display that four analysts report to one consultant, and five consultants report to one manger, and four managers report to one senior manager, and five senior managers that report to one executive.

FIG. 15 is a screenshot 1500 of a startup screen for viewing workforce demand trends. The workforce demand trends sheet allows the user to view the results of the workforce demand estimation. Workforce demand trends may be projected for each sub-function 1510. A view output button 1520 may correspond to each function 1510. For ease of use, such that the user can change a view with one click, in addition to the view output buttons 1520, the screenshot 1500 may display a return to demand estimation button 1530, a view supply estimation sheet button 1540, a view gap analysis button 1550, a return to user definition button 1560 and a return to input function data sheet button 1570.

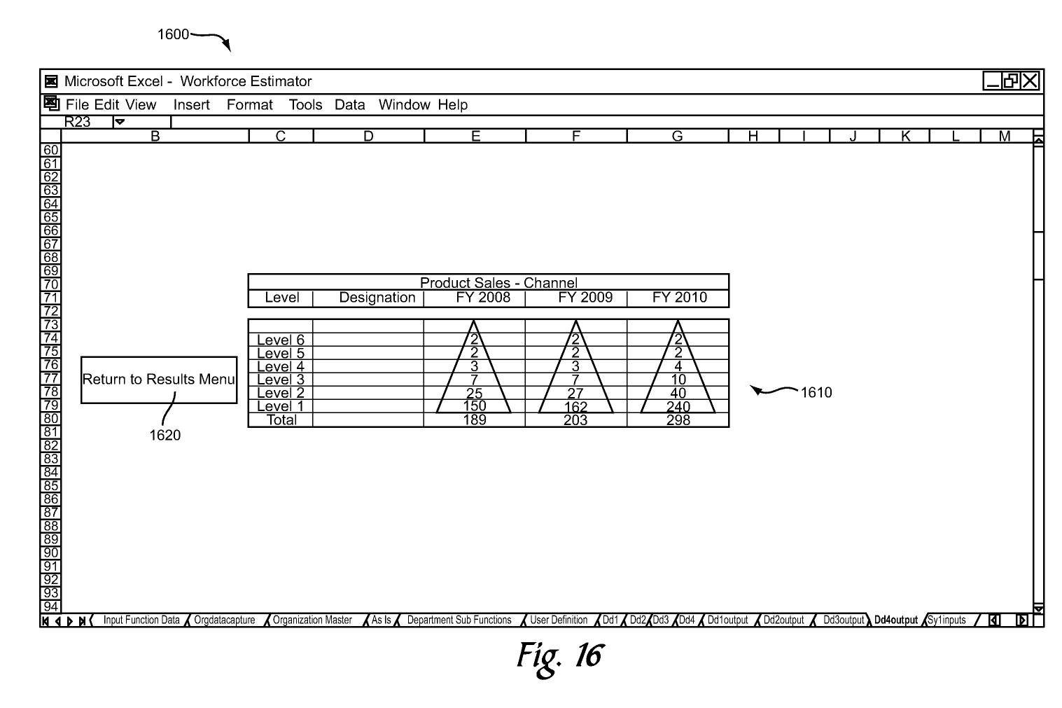

FIG. 16 is a screenshot 1600 that displays demand trends when the view output button 1520 of FIG. 15 is clicked. For example, an overall sales target for the product sales division is 900 million, and the tool 100 determines that on the basis of the industry average trends and past performance of level 1 employees, a level 1 employee is expected to contribute approximately 6 million towards the 900 million target. Therefore, a number of level 1 employees required is 900/6=150. For subsequent years, the target may be revised upwards on the basis of access to new markets or other organization/market forces. For example, in FY 2009, if the target is increased to 972 million and assuming the same productivity of 6 million per level 1 employee, 162 level 1 employees may be required. For level 2 and above, the number of employees required may be determined by span of control guidelines either on the basis of industry averages or organization history. For e.g. in 2008, the tool 100 may determine an average one level 2 employee to manage 6 level 1 employees, and therefore 25 level 2 employees are needed. For product sales channel, at 1610 the estimated output for the different levels in the various years is displayed. At level 1, in fiscal year (FY) 2008, 150 required employees is estimated. For level 1, in 2009, 162 required employees is estimated, and so forth. The user may click a return to results menu 1620 to return to the previous screen, such as to select another sub-function to view.

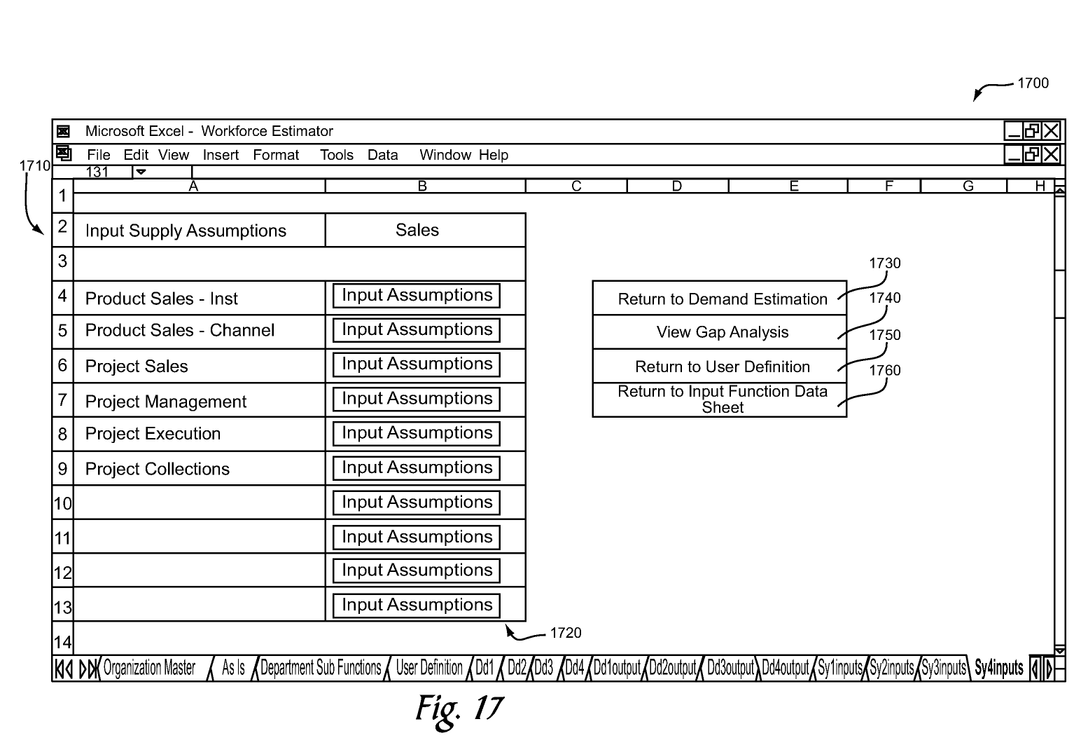

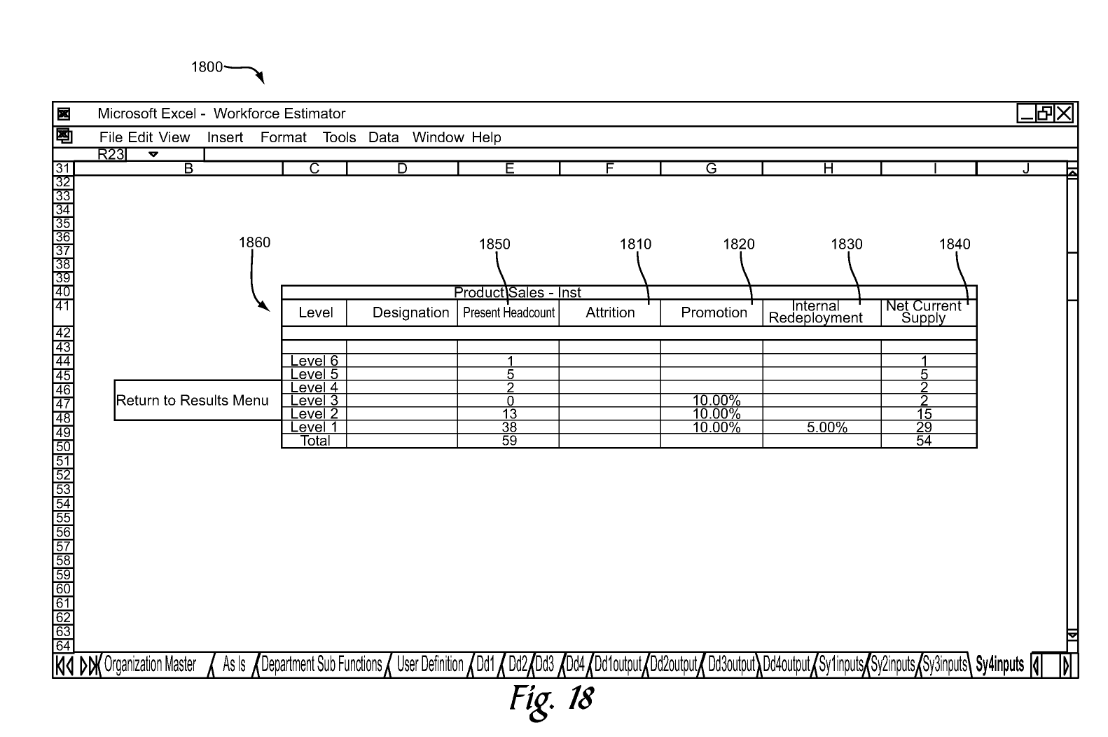

FIG. 17 is a screenshot 1700 of a startup screen for viewing estimates of workforce supply. At 1710, the functions and sub-functions may be displayed, such as institutional product sales, channel product sales, project sales, project management, project execution, and project collections. Input assumption buttons 1710 may correspond to the sub-functions. When the user clicks the input assumption button 1710, a screenshot that displays assumption data is displayed, such as in FIG. 18. Other buttons may include, return to demand estimation 1730, view gap analysis 1740, return to user definition 1750 and return to input function data sheet 1760, to allow the user to easily access these other parts of the tool 100.

FIG. 18 is a screenshot 1800 that displays workforce supply for a determined sub-function. Screenshot 1800 allows the user to view workforce supply determined for a particular time period, such as a year. Supply trends may incorporate different inputs, such as attrition 1810, promotion 1820 and job rotation 1830. The inputs may be updated by the user, such as in accordance with past trends and/or industry benchmarks. The attrition 1810, promotion 1820 and job rotation 1830 rates may vary, for example from about 2% to 45% per determined time period. Net current supply 1840 may be determined present headcount 1850 minus attrition 1810, promotion 1820 and job rotation 1830, for each level 1860 of the sub-function. Workforce supply figures for future years may be based on demand figures for the current year. For example, workforce supply numbers for FY 2009 may be equal to the workforce demand numbers for FY 2008. The tool 100 may also provide analysis on the inputs using industry benchmarks and organization data collected over time. The tool 100 may incorporate industry benchmarks on attrition and hiring trends.

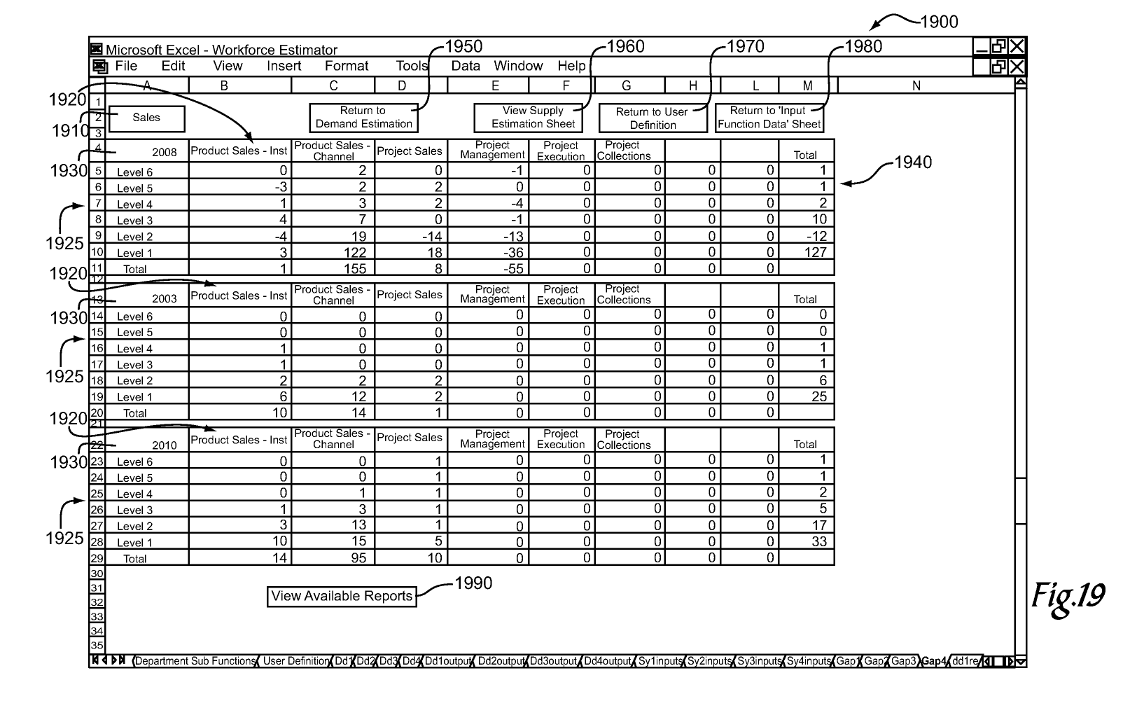

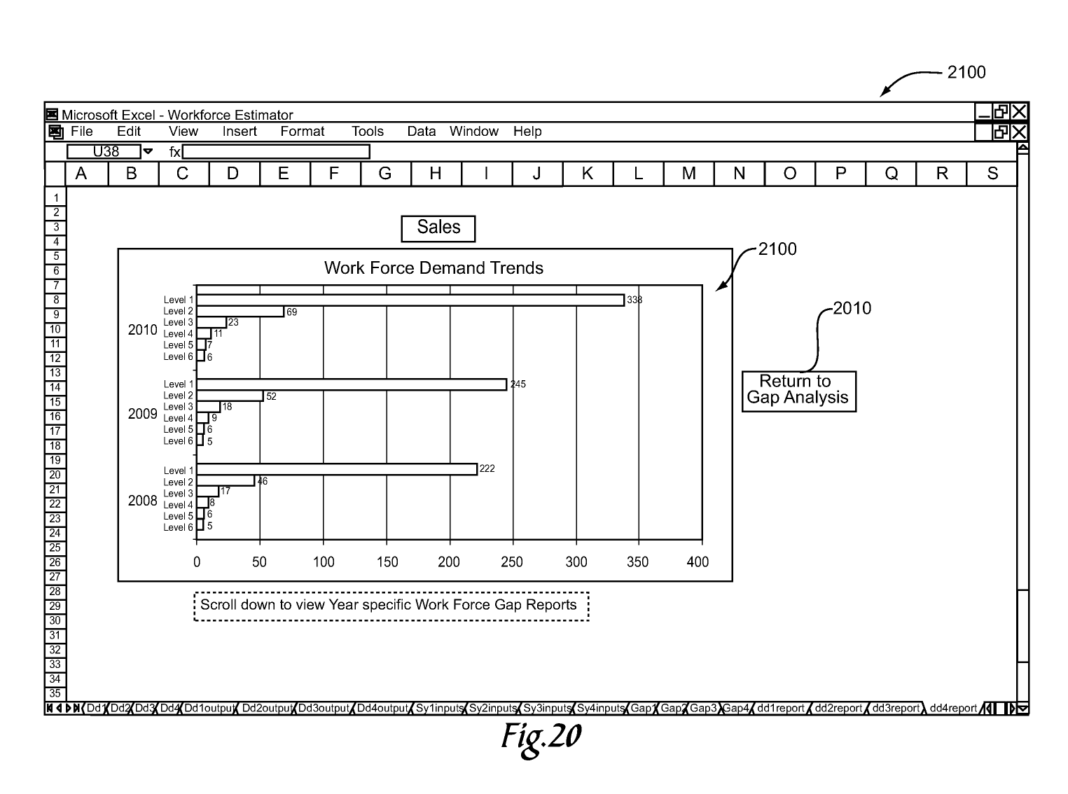

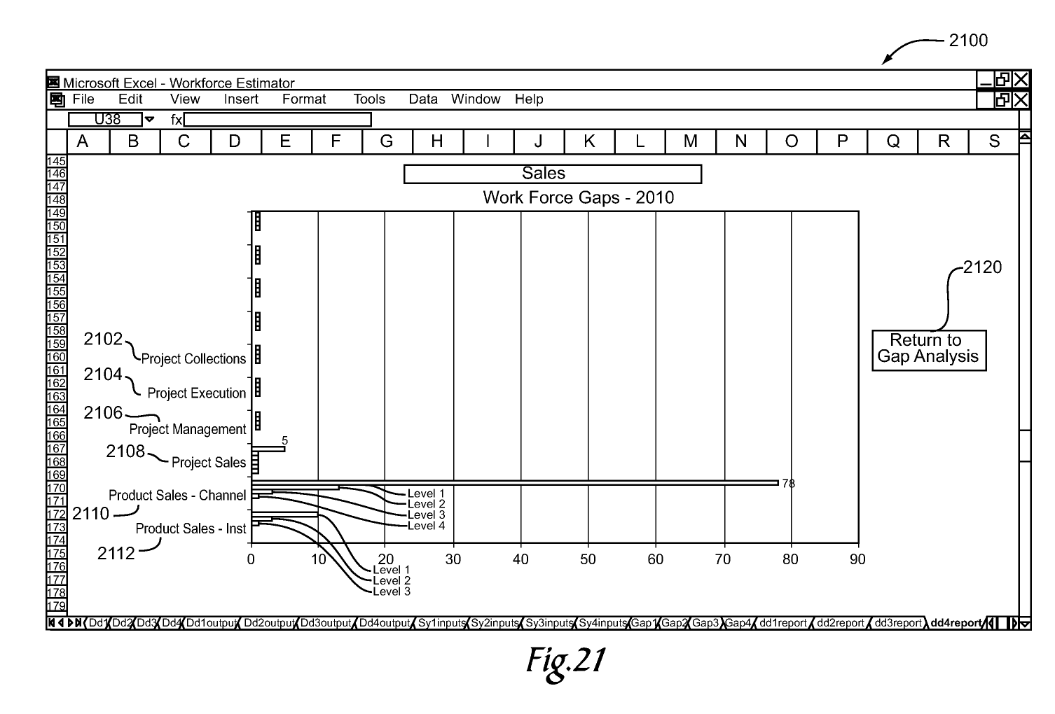

FIG. 19 is a screenshot that displays a summary sheet 1900 of the gap analysis such as for workforce gaps identified for a particular function and/or sub-function across positions over a determined time period, such as three years. The summary sheet 1900 may show the gap figures by job position 1910, such as sales, and sub-function 1920, at a particular level 1925 for determined years 1930, such as over a three year horizon. Total gaps 1940 may be displayed. To allow a user to navigate the tool 100, the summary sheet 1900 may also include a return to demand estimation button 1950, a view supply estimation sheet button 1960, a return to user definition button 1970, a return to input function data sheet button 1980 and a view available reports button 1990. Available reports may include the work force demand report in FIG. 20, or other reports, such as the workforce gaps report of FIG. 21.

FIG. 20 is a screenshot of a workforce demand trends report 2000. The demand trend report 2000 may be a default report of the tool 100, by function, such as sales, and position. The demand trends report 2000 may be in the form of a bar graph, to graphically represent the gaps over a determined time period, such as three years. A return to gap analysis button 2010 may be included to help the user navigate back to the gap analysis part of the tool 100.

FIG. 21 is a screenshot of a workforce gaps report 2100. The workforce gaps report 2100 may display workforce gaps, by level, for determined functions, such as sales, and sub-function, such as project collections 2102, project execution 2104, project management 2106, project sales 2108, product sales through channels 2110 and product sales for the institution 2112, and for a determined year. For example, in FY 2010 for project sales 2108 there is projected gap of five employees at level 1, and 1 employee at level 2 through 6. A return to gap analysis button 2120 may be included to help the user navigate back to the gap analysis part of the tool 100.

FIG. 22 is a screenshot 2200 of add driver functionality, such as with regard to the set up new driver button 1450 of FIG. 14. The screen allows a user to add and/or remove demand side drivers 2210, such as revenue, volume, effort, human capital ROI, and earnings, on an organization by organization basis. Each driver may be defined 2220, such as revenue per full time employee (FTE), volume per FTE, sales calls per FTE, PBIT as a factor of compensation cost, and net operating profit after tax (NOPAT) per FTE. Also, for each driver, one or more elements may be determined. Element 1 2230 may include revenue, volume, sales calls/effect/leads, PBIT and NOPAT. Element 2 2240 may include productivity for all driver except human capital ROI, and compensation costs for that.

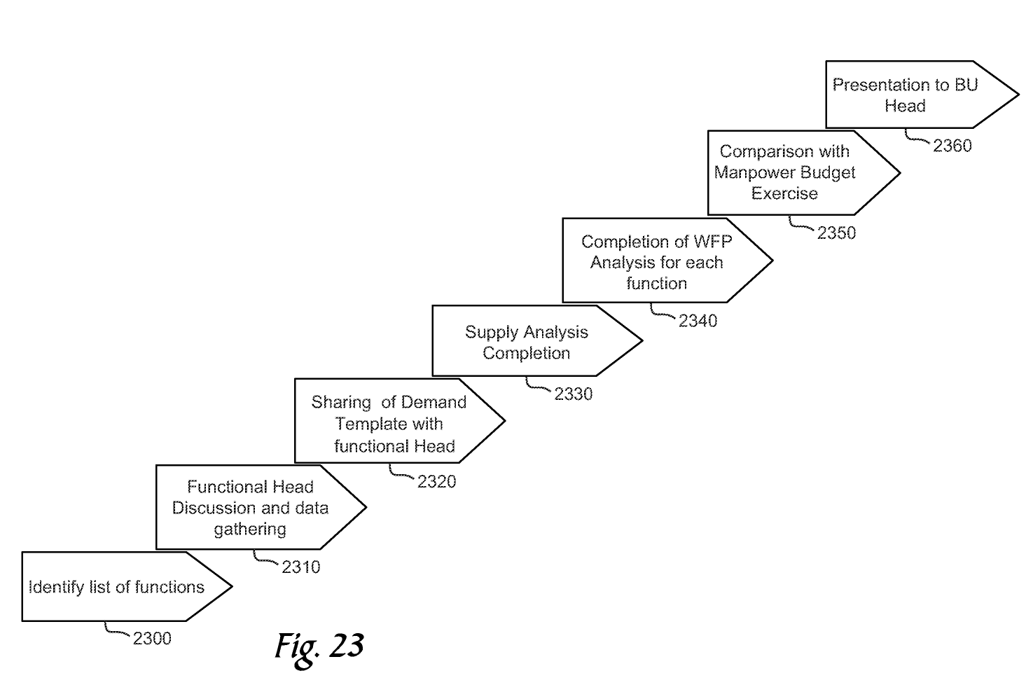

FIG. 23 is a flow diagram of a process of the workforce planning tool 100. The workforce planning tool 100 is a customizable tool 100 that allows for structured workforce planning across time horizons and organizational levels across multiple industries. At block 2300, a list of functions of the organization is identified. The organization structure is reviewed, such as on a business unit by business unit basis. The structure and unique jobs at the organization are reported in a unique job matrix. Functions and sub-functions within the business unit are identified that have separate people levers. A people levers template may be completed, based on an understanding of the functions, balanced scorecard (BSC) for the function and available reference lists of people levers and metrics.

At block 2310, there may be a discussion with the functional heads and more initial data gathering. Information may be collected via appointments with each functional/sub-functional head. The workforce planning tool 100 framework and people lever framework may be shared with the heads so that activities and performance parameters may be confirmed for the function as understood by line and HR partners. The people levers and productivity levers may then be finalized. Templates may be updated and sent to the functional heads. At that time, a request for a final sign-off of the templates and data input for finalized metrics may be made.

At block 2320, demand templates may be shared with the functional head. Demand estimation-data input templates may be created for the function translating the inputs received from the functional head into productivity metrics. The functional head may be requested to provide required data. The final outcome may then be shared with the functional heads. Sign-off, such as written, may also be requested.

At block 2330, supply analysis may be completed. Available employee based may be captured, such as from payroll and/or a third party, at each unique position. Workforce trends for the previous year may be captured with HR/Project team assistance. The workforce trends may be captured HR databases/enterprise resource planning (ERP). ERP business software may be used for running various aspects of a company including managing orders, inventory, accounting, and logistics. Known ERP software providers include BAAN, ORACLE, PEOPLESOFT and SAP, collectively known to industry insiders as the “BOPS”. Function-wise/unique job (UJ)-wise applicable trends for attritions, promotions and job rotations may be estimated. The trends may be reviewed by function heads, and signed off by them when they agree.

At block 2340, the workforce planning tool 100 analysis for each function may be completed. The supply module and gap analysis for the workforce planning tool 100 are used. At block 2350, the results of the workforce planning tool 100 may be compared with manpower budgets. Information required to conduct a comparison with the manpower budget, such as third party contract handling, may be ascertained. At block 2360, the outcome of the analysis may be presented to the business unit head. The outcome may include a summary and function-wise details. The business unit head may sign off on the presented analysis.

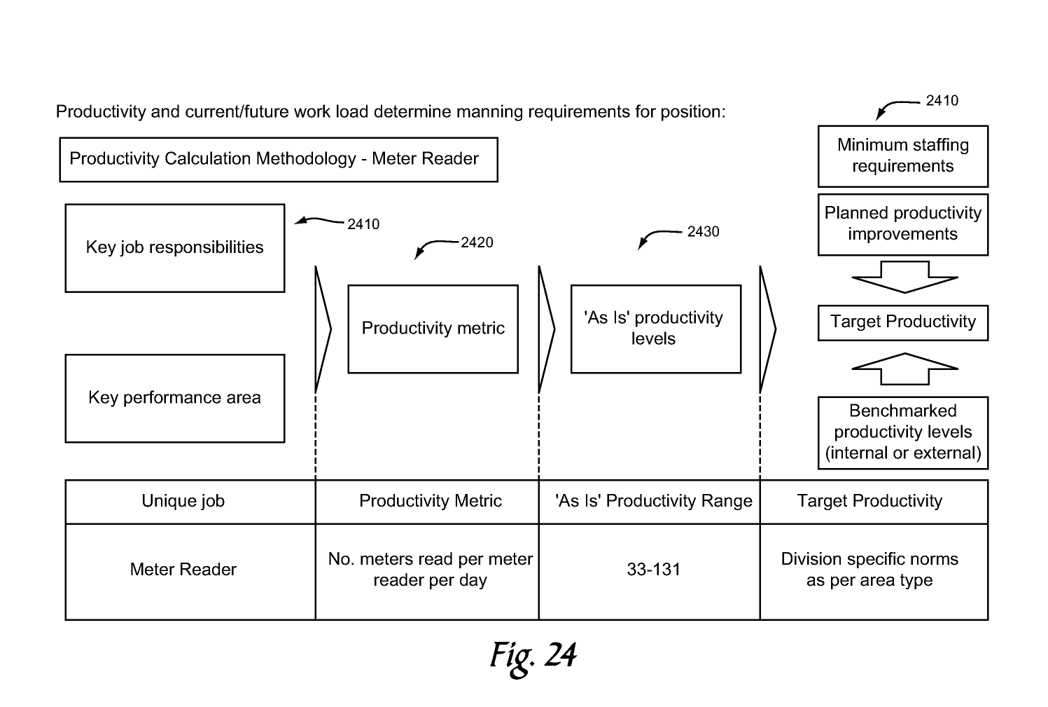

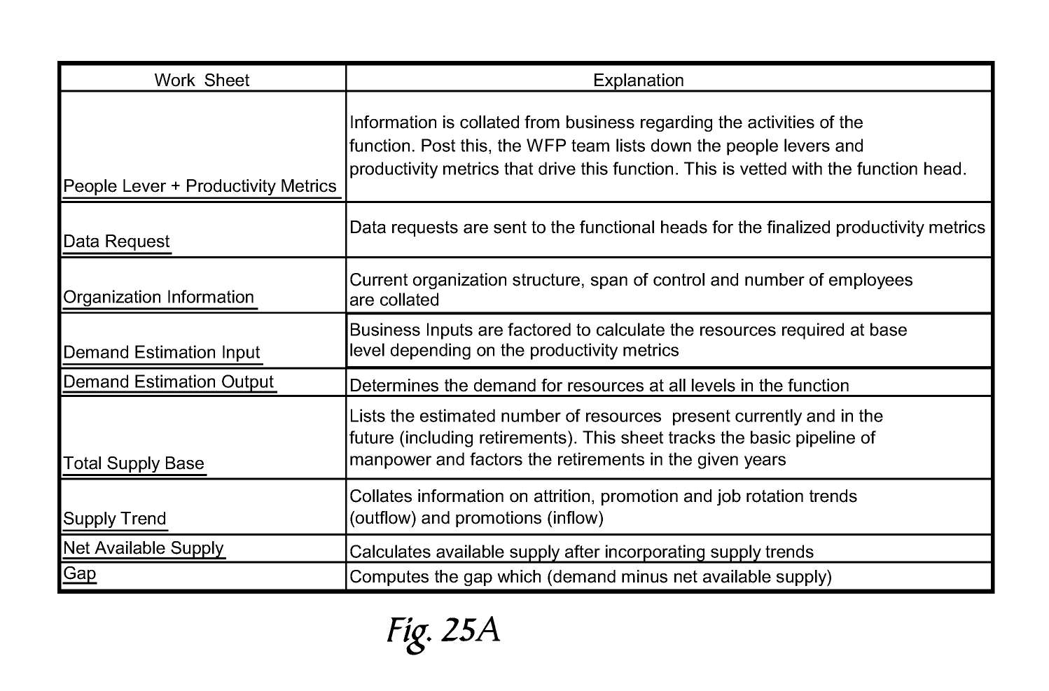

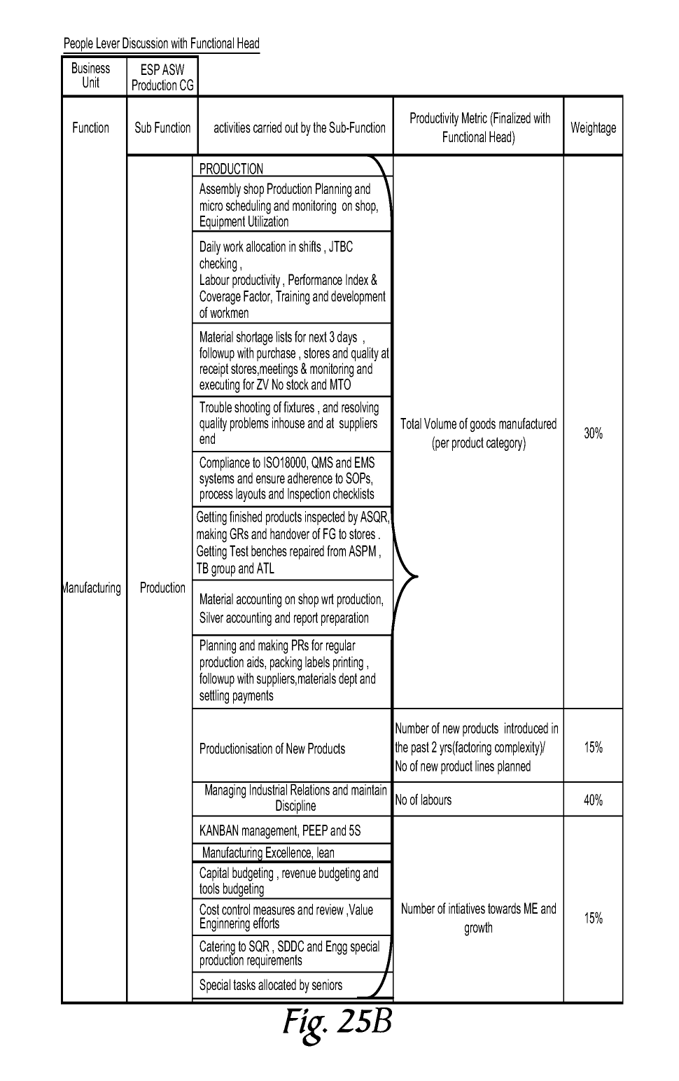

FIG. 24 is a block diagram of a methodology of exemplary productivity determinations. For explanation purposes, the determination is made in terms of a meter reader for an organization. A similar methodology may be used to determine productivity for other sub-functions, such as customer care. At 2410, for the meter reader, job responsibilities and performance areas are established. In this example, the job responsibility and performance area is reading meters. At block 2420, a productivity metric may be determined, such as a number of meters read per meter reading day. In the customer care example, the productivity metric may be number of customer walk-ins handled by customer care per day. At block 2430, an as-is productivity range is determined, such as for all the meter readers across all the divisions and offices of the organization. In this example, the range of meters read per day is thirty-three to one hundred and thirty-one.

At block 2440, a target productivity may be determined. The target productivity may include factors such as minimum staffing requirements, planned productivity improvement, and benchmarked productivity levels, such as within the organization and outside of the organization, within the industry. To determine target productivity internally, the number of meters read may be charted per division. A productivity norm may be calculated for the group. The norm may take into account different factors. In the meter reading example, a number of meters read in high rise buildings, shopping areas, industrial area, farm houses, villages, unauthorized colonies, etc. may be considered. A percentage of consumers per area may be considered. An actual division of productivity levels may be considered. Productivity at 75% of the area norm may be taken a base level target productivity for divisions with current productivity greater than 50% of the norm, and 60% of the area norm taken for all other divisions. Excess and deficit personnel per division may be considered with regard to the as-is workforce and to-be workforce. New customer acquisitions, or loss of customers, may be factored, such as based on organization growth forecasts and business plans.

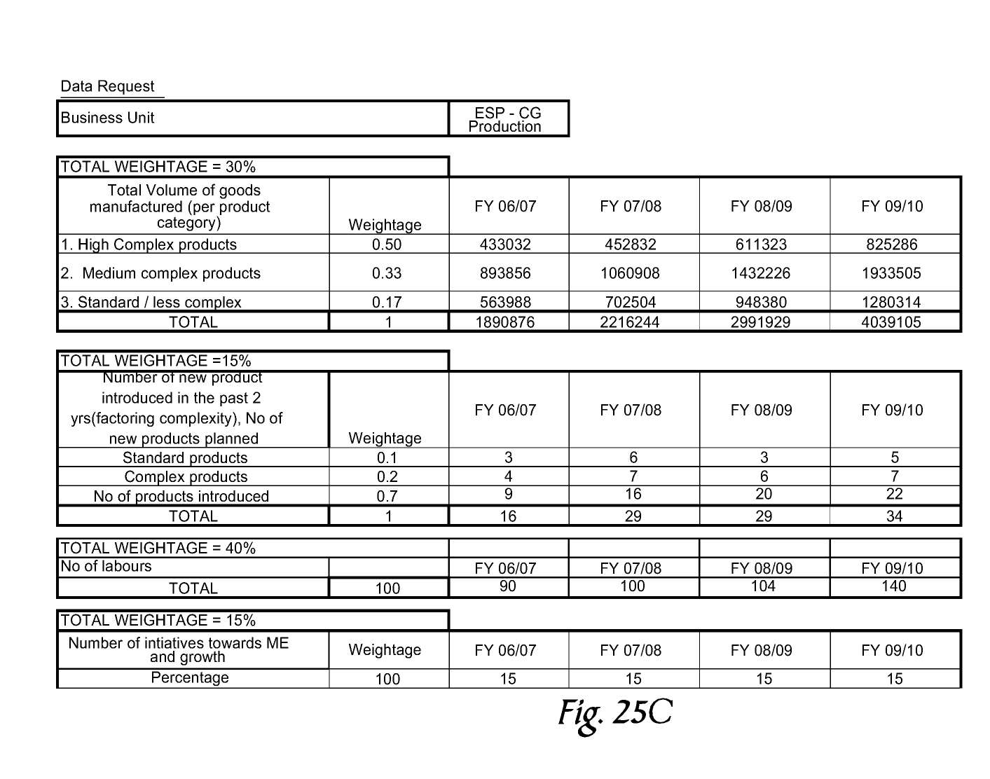

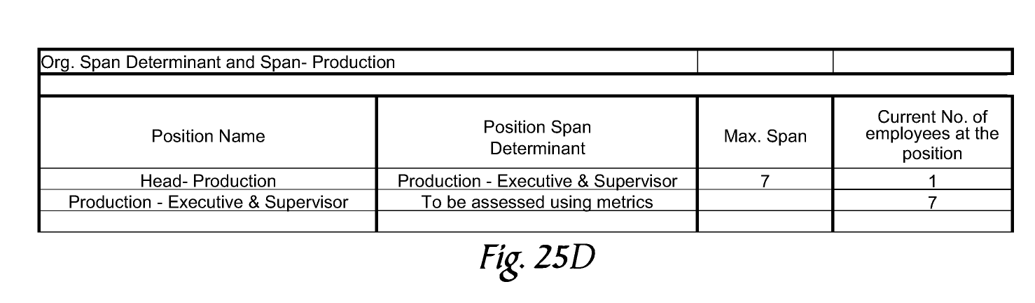

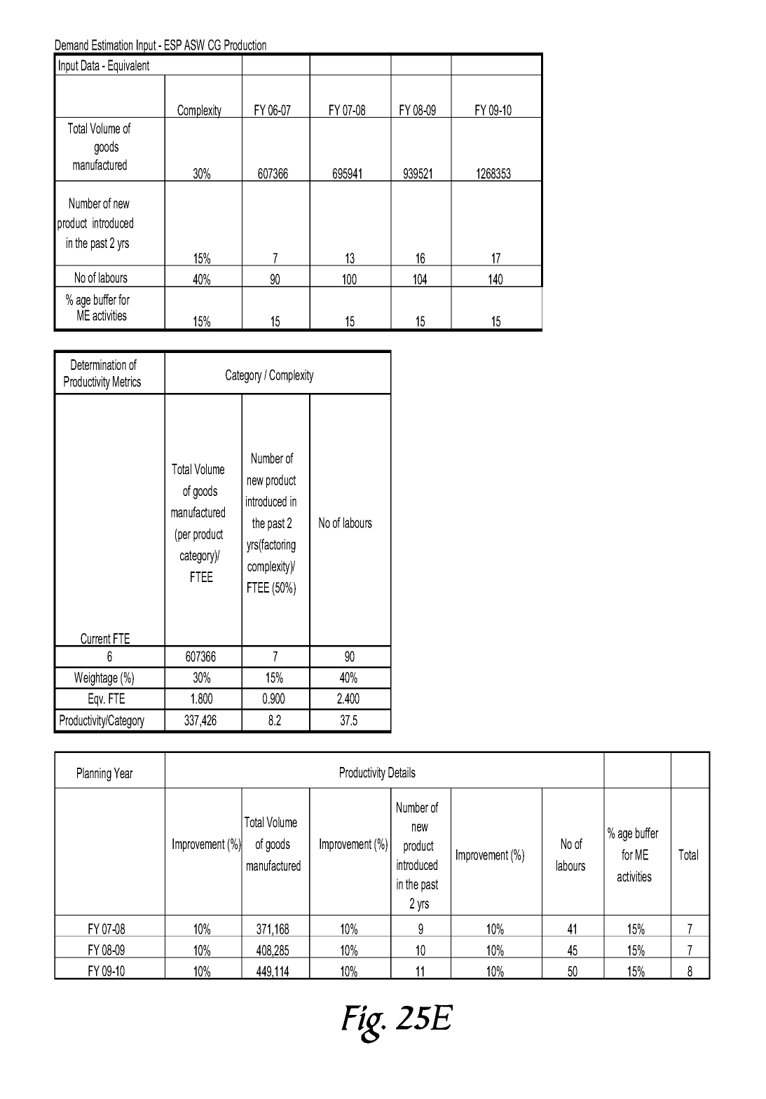

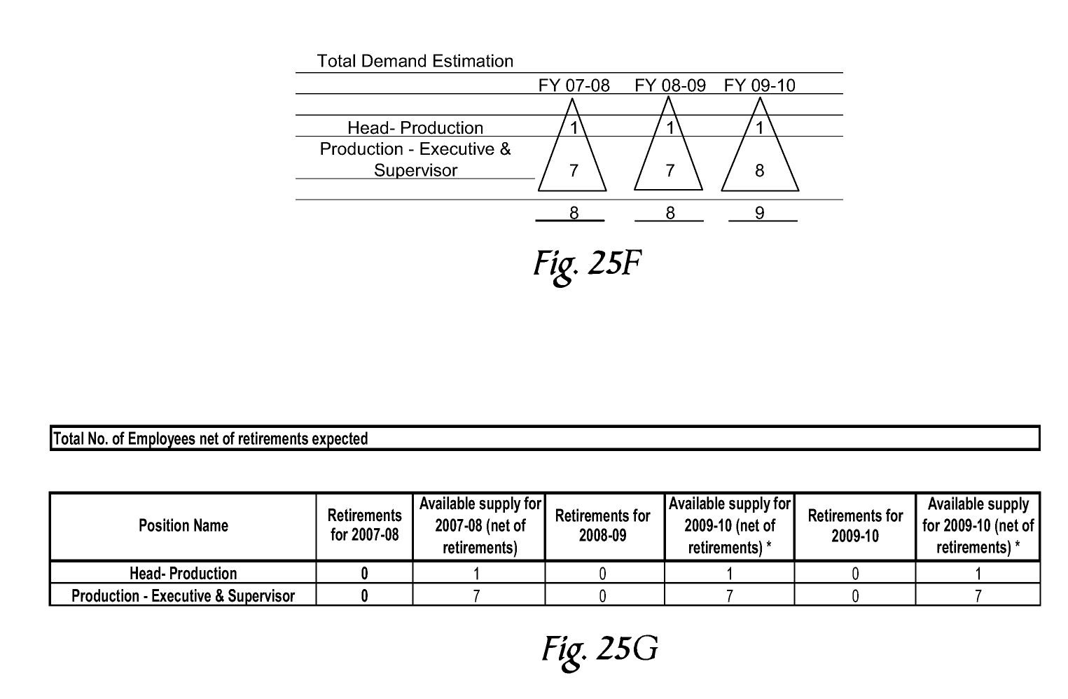

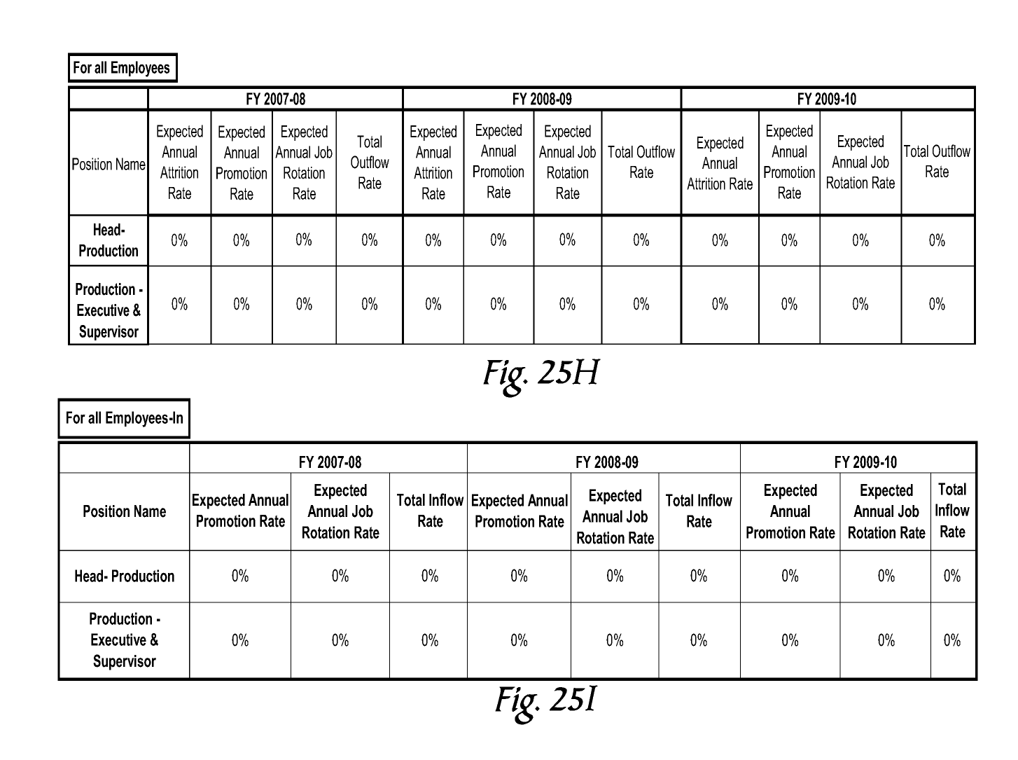

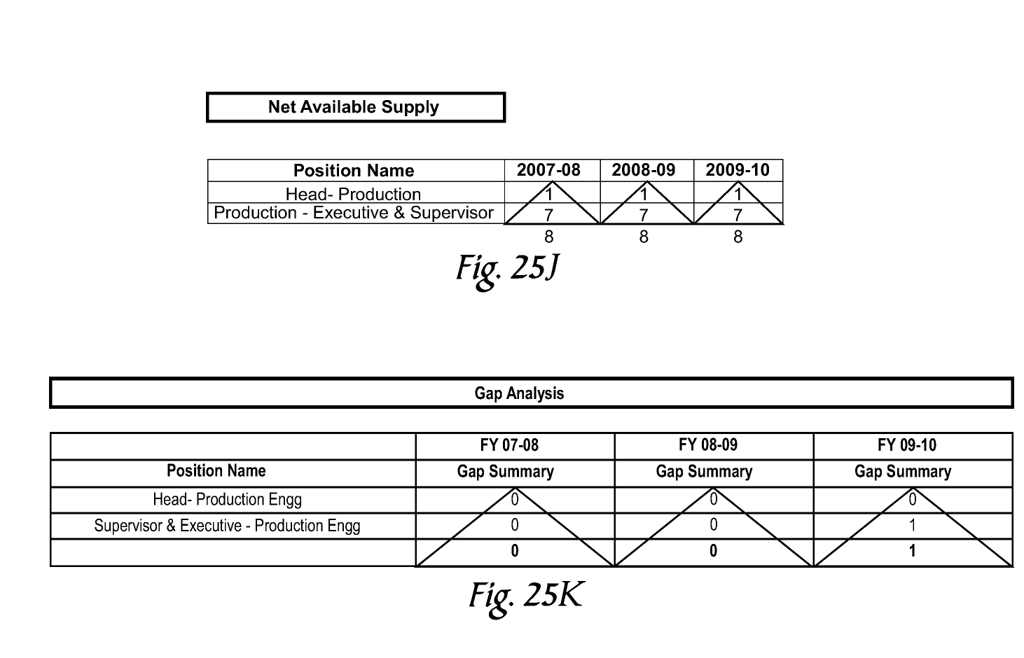

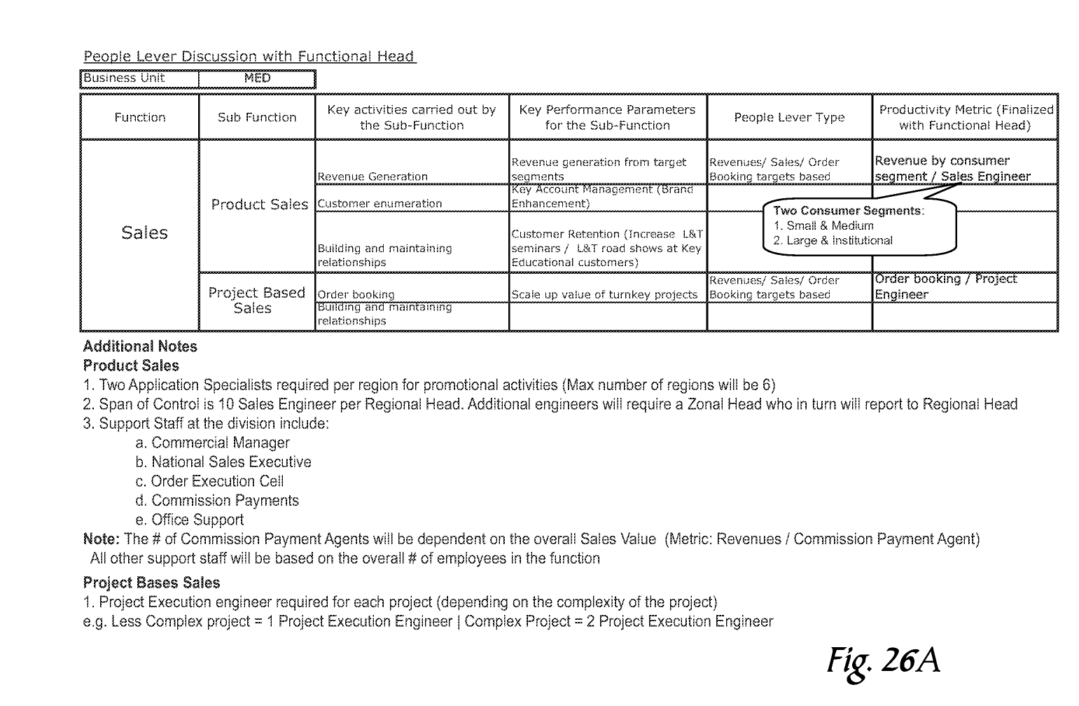

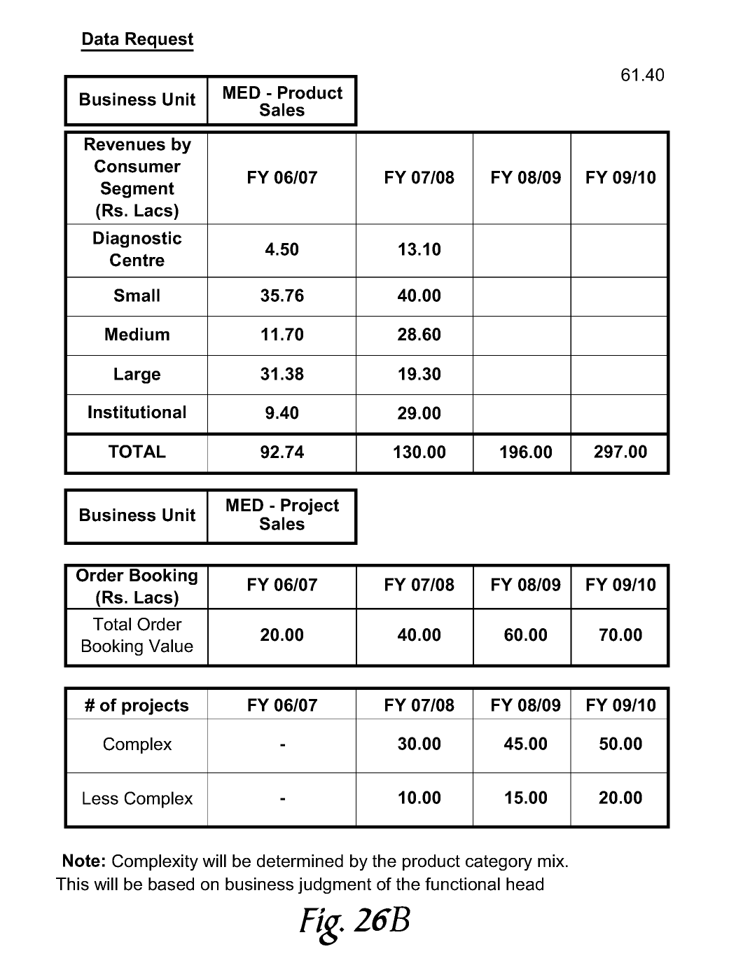

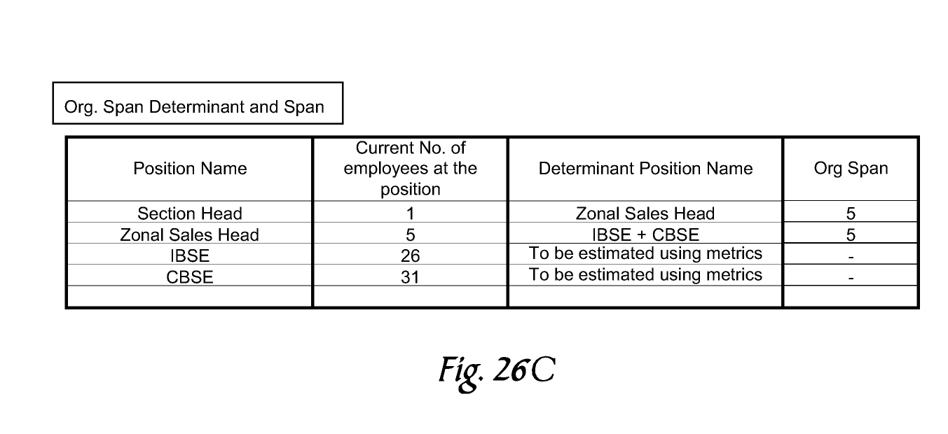

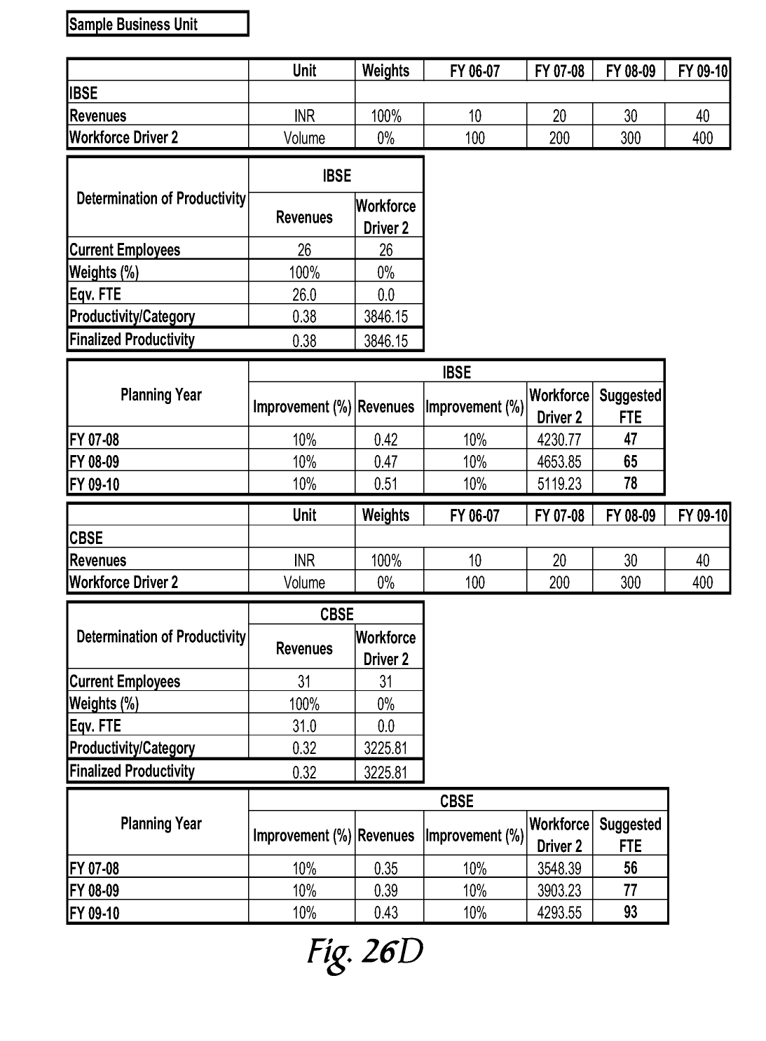

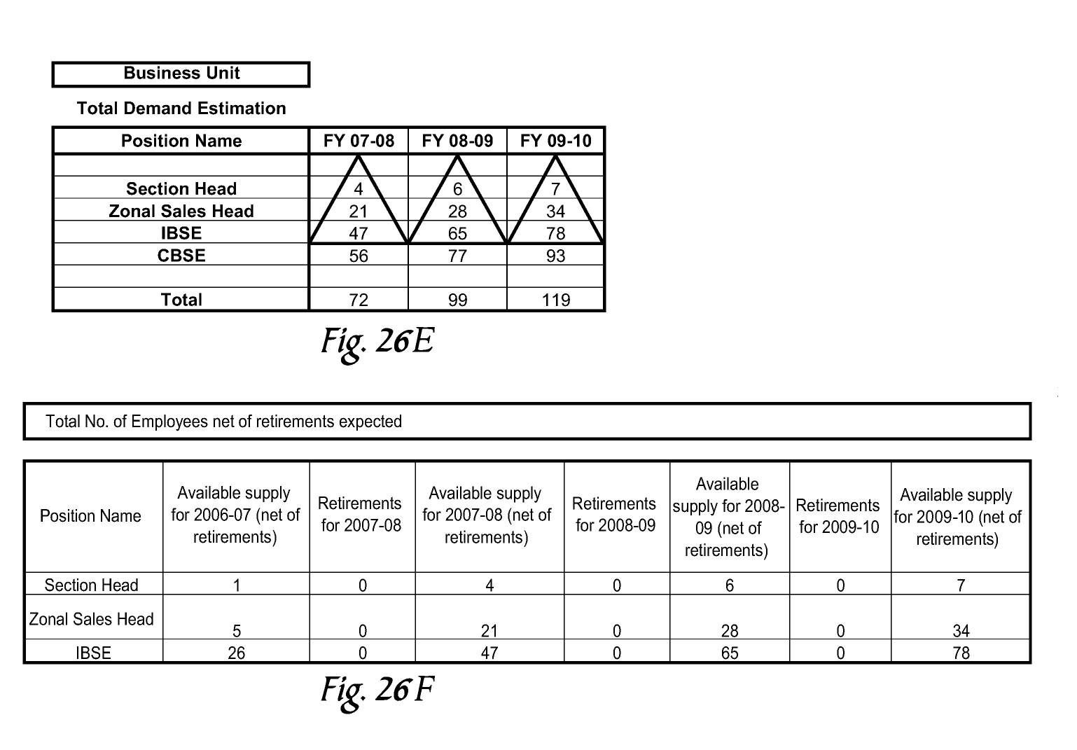

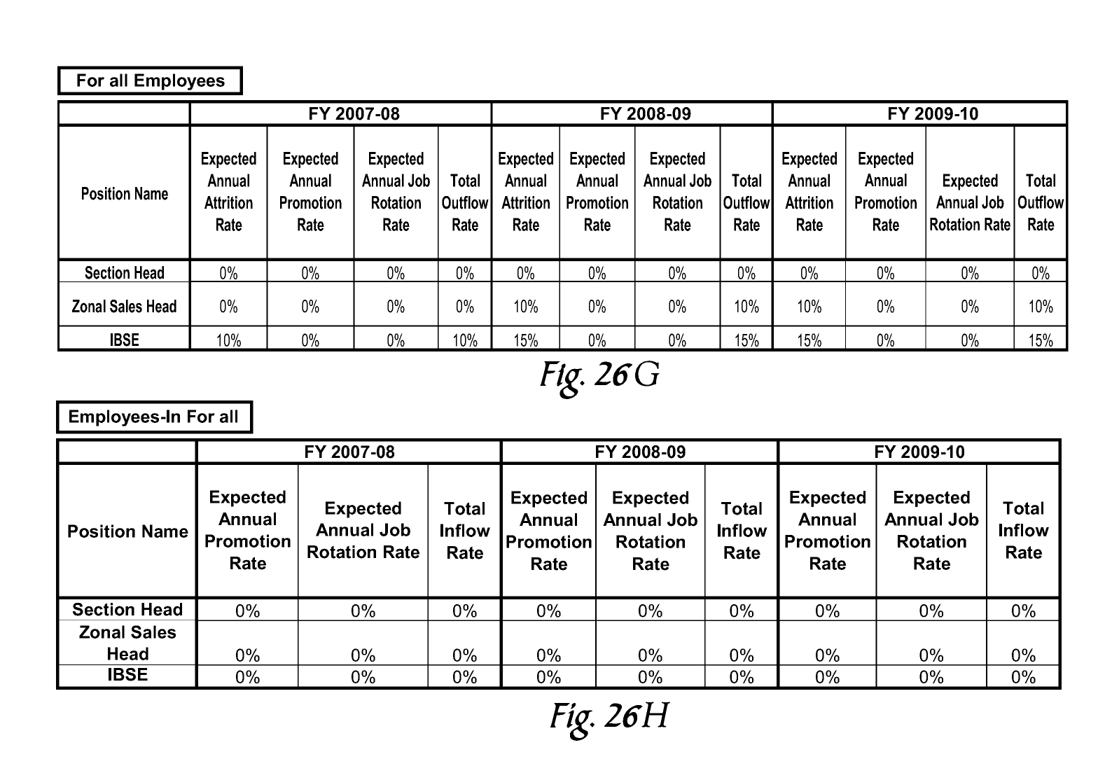

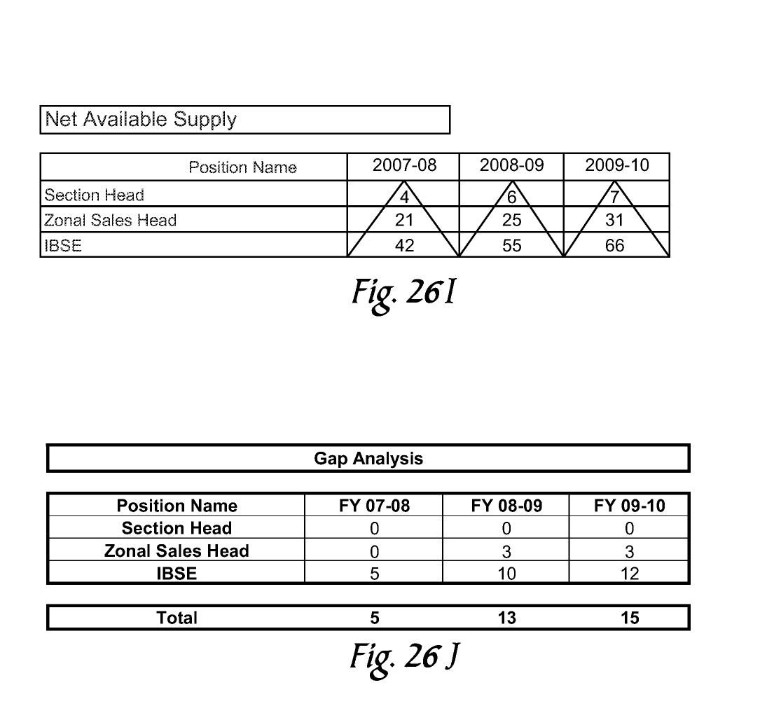

FIGS. 25A-K is a first example of output using the workforce planning tool 100. FIGS. 26A-J is a second example of output using the workforce planning tool 100. FIG. 27 is a screenshot of outputs of an exemplary benefit of using the tool 100, according to the methodology of FIG. 7.

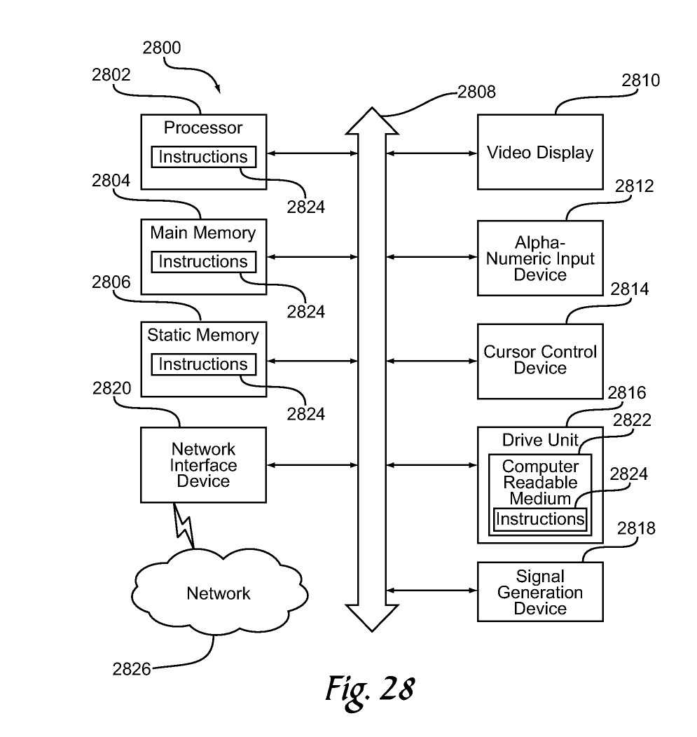

FIG. 28 illustrates a general computer system 2800 that may be used with the workforce planning tool 100. The computer system 2800 may include a set of instructions that can be executed to cause the computer system 2800 to perform any one or more of the methods or computer based functions disclosed herein. The computer system 2800 may operate as a standalone device or may be connected, e.g., using a network, to other computer systems or peripheral devices. The tool 100 may be implemented hardware, software or firmware, or any combination thereof. Alternative software implementations may be used including, but not limited to, distributed processing or component/object distributed processing, parallel processing, or virtual machine processing may also be constructed to implement the tools 100 described herein.

In a networked deployment, the computer system 2800 may operate in the capacity of a server or as a client user computer in a server-client user network environment, or as a peer computer system in a peer-to-peer (or distributed) network environment. The computer system 2800 may also be implemented as or incorporated into various devices, such as a personal computer (PC), a tablet PC, a set-top box (STB), a personal digital assistant (PDA), a mobile device, a palmtop computer, a laptop computer, a desktop computer, a communications device, or any other machine capable of executing a set of instructions (sequential or otherwise) that specify actions to be taken by that machine. The computer system 2800 may be implemented using electronic devices that provide voice, video or data communication. Further, while a single computer system 2800 is illustrated, the term “system” shall also be taken to include any collection of systems or sub-systems that individually or jointly execute a set, or multiple sets, of instructions to perform one or more computer functions.

In FIG. 28, the computer system 2800 may include a processor 2802, e.g., a central processing unit (CPU), a graphics processing unit (GPU), or both. Moreover, the computer system 2800 may include a main memory 2804 and a static memory 2806 that may communicate with each other via a bus 2808. The computer system 2800 may further include a video display unit 2810, such as a liquid crystal display (LCD), an organic light emitting diode (OLED), a flat panel display, a solid state display, or a cathode ray tube (CRT). Additionally, the computer system 2800 may include an input device 2812, such as a keyboard, and a cursor control device 2814, such as a mouse. The computer system 2800 may also include a disk drive unit 2816, a signal generation device 2818, such as a speaker or remote control, and a network interface device 2820.

In FIG. 28, the disk drive unit 2816 may include a computer-readable medium 2822 in which one or more sets of instructions 2824, e.g. software, may be embedded. Further, the instructions 2824 may embody one or more of the methods or logic as described herein. In a particular embodiment, the instructions 2824 may reside completely, or at least partially, within the main memory 2804, the static memory 2806, and/or within the processor 2802 during execution by the computer system 2800. The main memory 2804 and the processor 2802 also may include computer-readable media.

Dedicated hardware implementations, such as application specific integrated circuits, programmable logic arrays and other hardware devices, may be constructed to implement one or more of the tools 100 described herein. Applications that may include the apparatus and systems of various embodiments may broadly include a variety of electronic and computer systems. One or more embodiments described herein may implement functions using two or more specific interconnected hardware modules or devices with related control and data signals that may be communicated between and through the modules, or as portions of an application-specific integrated circuit.

The present disclosure contemplates a computer-readable medium that includes instructions 2824 or receives and executes instructions 2824 responsive to a propagated signal so that a device connected to a network 2826 may communicate voice, video or data over the network 2826. Further, the instructions 2824 may be transmitted or received over the network 2826 via the network interface device 2820. While the computer-readable medium is shown to be a single medium, the term “computer-readable medium” includes a single medium or multiple media, such as a centralized or distributed database, and/or associated caches and servers that store one or more sets of instructions. The term “computer-readable medium” also includes any medium that is capable of storing, encoding or carrying a set of instructions for execution by a processor or that cause a computer system to perform any one or more of the methods or operations disclosed herein.

The computer-readable medium may include a solid-state memory such as a memory card or other package that houses one or more non-volatile read-only memories. Further, the computer-readable medium may be a random access memory or other volatile re-writable memory. Additionally, the computer-readable medium may include a magneto-optical or optical medium, such as a disk or tapes or other storage device to capture carrier wave signals such as a signal communicated over a transmission medium. A digital file attachment to an e-mail or other self-contained information archive or set of archives may be considered a distribution medium that is equivalent to a tangible storage medium. Accordingly, the disclosure is considered to include any one or more of a computer-readable medium or a distribution medium and other equivalents and successor media, in which data or instructions may be stored.

Although the present specification describes components and functions that may be implemented in particular embodiments with reference to particular standards and protocols, the invention is not limited to such standards and protocols. For example, standards for Internet and other packet switched network transmission (e.g., TCP/IP, UDP/IP, HTML, HTTP) represent examples of the state of the art. Such standards are periodically superseded by faster or more efficient equivalents having essentially the same functions. Accordingly, replacement standards and protocols having the same or similar functions as those disclosed herein are considered equivalents thereof.

The illustrations of the embodiments described herein are intended to provide a general understanding of the structure of the various embodiments. The illustrations are not intended to serve as a complete description of all of the elements and features of apparatus and systems that utilize the structures or methods described herein. Many other embodiments may be apparent upon reviewing the disclosure. Other embodiments may be utilized and derived from the disclosure, such that structural and logical substitutions and changes may be made without departing from the scope of the disclosure. Additionally, the illustrations are merely representational and may not be drawn to scale. Certain proportions within the illustrations may be exaggerated, while other proportions may be minimized. Accordingly, the disclosure and the figures are to be regarded as illustrative rather than restrictive.

Although specific embodiments have been illustrated and described herein, it should be appreciated that any subsequent arrangement designed to achieve the same or similar purpose may be substituted for the specific embodiments shown. This disclosure is intended to cover any and all subsequent adaptations or variations of various embodiments. Combinations of the above embodiments, and other embodiments not specifically described herein, will be apparent to those of skill in the art upon reviewing the description.

The above disclosed subject matter is to be considered illustrative, and not restrictive, and the appended claims are intended to cover all such modifications, enhancements, and other embodiments, which fall within the true spirit and scope of the present invention. Thus, to the maximum extent allowed by law, the scope of the present invention is to be determined by the broadest permissible interpretation of the following claims and their equivalents, and shall not be restricted or limited by the foregoing detailed description.

We claim:

1. A computer implemented method for planning workforce requirements for an organization, wherein the organization is organized into functional areas, comprising:
receiving an input of a workforce supply for the organization;
receiving an input of a workforce demand, wherein the workforce demand includes an organizational direction of the organization, including strategic planning and current performance of the organization, and includes productivity levers, including productivity metrics for each of the functional areas of the organization; and
determining a workforce gap by comparing the workforce demand to the workforce supply.

2. The method of claim 1, wherein the workforce gap is determined for each of the functional areas of the organization.

3. The method of claim 2, wherein the functional areas comprise operational groups within the organization.

4. The method of claim 2, wherein the functional areas comprise teams of a business within the organization

5. The method of claim 2, wherein the functional areas comprise sub-functions.

6. The method of claim 5, wherein the workforce gap is determined for the sub-functions.

7. The method of claim 1, further including levels within the functions of the organization.

8. The method of claim 7, wherein the workforce gap is determined for each of the levels.

9. The method of claim 8, wherein the workforce gap is further determined for each of the functions.

10. The method of claim 1, further comprising attending to the workforce gap after forecasting the workforce gap, and updating the inputted workforce supply accordingly.

11. The method of claim 10, wherein attending to the workforce gap includes implementing workforce changes with at least one of workforce increases, workforce decreases, redeployment of the workforce, and retraining of the workforce.

12. The method of claim 1, wherein the forecasting occurs periodically for the organization.

13. The method of claim 12, wherein the workforce gap is forecasted for a time period of more than one year into the future.

14. A computer implemented system for planning workforce requirements for an organization, wherein the organization is organized into functional areas, and the functional areas being organized into tiers, the system comprising:
logic to receive an input of a workforce supply for the organization;
logic to receive an input of a workforce demand, wherein the workforce demand includes an organizational direction of the organization, including strategic planning and current performance of the organization, and includes productivity levers, including productivity metrics for each of the functional areas of the organization;
logic to determine a workforce gap by comparing the workforce demand to the workforce supply; and
logic to display the determined workforce gap, wherein the display includes gap information for each of the functional areas and the tiers of the organization.

15. The system of claim 14, wherein the functional areas comprise operational groups within the organization.

16. The system of claim 14, wherein the functional area comprises teams of a business within the organization

17. The system of claim 14, wherein the tiers comprise levels within the functions of the organization.

18. The system of claim 14, wherein the forecasting occurs periodically for the organization.

19. The system of claim 18, wherein the workforce gap is forecasted for a time period of more than one year into the future.

20. The system of claim 14, wherein the workforce supply includes the current workforce, attrition trends, planned promotions and scheduled retirement.
